(19) United States
(12) Patent Application Publication
(10) Pub. No.: US 2025/0035888 A1
(43) Pub. Date: Jan. 30, 2025

(54) OPTICAL IMAGING SYSTEM

(71) Applicant: SAMSUNG ELECTRO-MECHANICS CO., LTD., Suwon-si (KR)

(72) Inventors: Dong Hyuk JANG, Suwon-si (KR); Ji Su LEE, Suwon-si (KR); Il Yong PARK, Suwon-si (KR)

(73) Assignee: SAMSUNG ELECTRO-MECHANICS CO., LTD., Suwon-si (KR)

(21) Appl. No.: 18/916,961

(22) Filed: Oct. 16, 2024

Related U.S. Application Data
(63) Continuation of application No. 18/199,016, filed on May 18, 2023.

(30) Foreign Application Priority Data
Sep. 14, 2022 (KR) 10-2022-0115737

(51) Int. Cl. G02B 9/64; G02B 13/00

(52) U.S. Cl. CPC G02B 9/64; G02B 13/0045

(57) ABSTRACT

An optical imaging system includes a first lens having positive refractive power, a second lens having negative refractive power, a third lens, a fourth lens, a fifth lens, a sixth lens, a seventh lens, and an eighth lens disposed in order from an object side. A refractive index of the second lens is greater than a refractive index of each of the first lens and the third lens. The optical imaging system satisfies TTL/(2×IMG HT)<0.6 and 0<f1/f<1.4, where TTL is a distance on an optical axis from an object-side surface of the first lens to an imaging plane, IMG HT is half a diagonal length of the imaging plane, f is a total focal length of the optical imaging system, and f1 is a focal length of the first lens.

### CROSS-REFERENCE TO RELATED APPLICATION(S)

This application is a continuation of U.S. application Ser. No. 18/199,016 filed on May 18, 2023, which claims the benefit under 35 USC 119(a) of Korean Patent Application No. 10-2022-0115737 filed on Sep. 14, 2022 in the Korean Intellectual Property Office, the entire disclosures of which are incorporated herein by reference for all purposes.

### BACKGROUND

### Field

The following description relates to an optical imaging system.

### Description of the Background

A recent portable terminal may include a camera provided with an optical imaging system including a plurality of lenses to perform video calls and to capture images.

As a function of cameras in portable terminals has gradually increased, demand for a camera for a portable terminal having a high resolution has increased.

Particularly, recently, an image sensor having a high pixel count (e.g., 13 million to 100 million pixels) has been employed in a camera for a portable terminal to implement clearer image quality.

That is, the size of the image sensor has increased, and accordingly, a total length of an optical imaging system has also been increased, such that there may be an issue in which a camera protrudes from a portable terminal.

Also, since a portable terminal has designed to have a smaller size and a camera for portable terminals has also required to have a reduced size, it has been necessary to develop an optical imaging system having a slim size and implementing high resolution.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens having positive refractive power, a second lens having negative refractive power, a third lens, a fourth lens, a fifth lens, a sixth lens, a seventh lens, and an eighth lens disposed in order from an object side. A refractive index of the second lens is greater than a refractive index of each of the first lens and the third lens. The optical imaging system satisfies TTL/(2×IMG HT)<0.6 and 0<f1/f<1.4, where TTL is a distance on an optical axis from an object-side surface of the first lens to an imaging plane, IMG HT is half a diagonal length of the imaging plane, f is a total focal length of the optical imaging system, and f1 is a focal length of the first lens.

Among the first to eighth lenses, at least three lenses including the second lens may have a refractive index greater than 1.61, and among the at least three lenses having a refractive index greater than 1.61, an absolute value of a focal length of the second lens may be the smallest.

At least one of 25<v1−v2<45, v1−v4<45 and 10<v1−(v6+v7)/2<30 may be satisfied, where v1 is an Abbe number of the first lens, v2 is an Abbe number of the second lens, v4 is an Abbe number of the fourth lens, v6 is an Abbe number of the sixth lens, and v7 is an Abbe number of the seventh lens.

The second lens, the fifth lens, and the sixth lens may have a refractive index greater than 1.61, and 60<v2+v5+v6<80 may be satisfied, where v2 is an Abbe number of the second lens, v5 is an Abbe number of the fifth lens, and v6 is an Abbe number of the sixth lens.

The fifth lens may have negative refractive power, and each of the second lens and the fifth lens may have a refractive index greater than 1.66.

The optical imaging system may satisfy −10<f2/f<−1; 1<|f3/f|; and 3<|f4/f|, where f2 is a focal length of the second lens, f3 is a focal length of the third lens, and f4 is a focal length of the fourth lens

The optical imaging system may satisfy −0.6<f1/f2<0.

The optical imaging system may satisfy −0.1<f1/f3<1.

The optical imaging system may satisfy 0<|f2/f3|<1.

The optical imaging system may satisfy 1.5<f34/f<5.5, where f34 is a combined focal length of the third lens and the fourth lens.

The optical imaging system may satisfy at least one of 3<|f5/f|; 1<|f6/f|; 0<f7/f<2; and −1<f8/f<0, where f5 is a focal length of the fifth lens, f6 is a focal length of the sixth lens, f7 is a focal length of the seventh lens, and f8 is a focal length of the eighth lens.

The optical imaging system may satisfy TTL/f<1.3 and BFL/f<0.3, where BFL is a distance on the optical axis from an image-side surface of the eighth lens to the imaging surface.

The optical imaging system may satisfy 0<D1/f<0.1, where D1 is a distance on the optical axis from an image-side surface of the first lens to an object-side surface of the second lens.

The optical imaging system may satisfy 0<D3/f<0.2, where D3 is a distance on the optical axis from the image-side surface of the third lens to an object-side surface of the fourth lens.

The optical imaging system may satisfy 70°<FOV×(IMG HT/f), where FOV is a field of view of the optical imaging system.

The fourth lens may have positive refractive power, the fifth lens may have negative refractive power, the seventh lens may have positive refractive power, and the eighth lens may have negative refractive power.

Other features and aspects will be apparent from the following detailed description, the drawings, and the claims.

### BRIEF DESCRIPTION OF DRAWINGS

FIG. 1 is a diagram illustrating an optical imaging system according to a first example.

FIG. 2 is curves indicating aberration properties of the optical imaging system illustrated in FIG. 1.

FIG. 3 is a diagram illustrating an optical imaging system according to a second example.

FIG. 4 is curves indicating aberration properties of the optical imaging system illustrated in FIG. 3.

FIG. 5 is a diagram illustrating an optical imaging system according to a third example.

FIG. 6 is curves indicating aberration properties of the optical imaging system illustrated in FIG. 5.

FIG. 7 is a diagram illustrating an optical imaging system according to a fourth example.

FIG. 8 is curves indicating aberration properties of the optical imaging system illustrated in FIG. 7.

FIG. 9 is a diagram illustrating an optical imaging system according to a fifth example.

FIG. 10 is curves indicating aberration properties of the optical imaging system illustrated in FIG. 9.

FIG. 11 is a diagram illustrating an optical imaging system according to a sixth example.

FIG. 12 is curves indicating aberration properties of the optical imaging system illustrated in FIG. 11.

FIG. 13 is a diagram illustrating an optical imaging system according to a seventh example.

FIG. 14 is curves indicating aberration properties of the optical imaging system illustrated in FIG. 13.

FIG. 15 is a diagram illustrating an optical imaging system according to an eighth example.

FIG. 16 is curves indicating aberration properties of the optical imaging system illustrated in FIG. 15.

Throughout the drawings and the detailed description, the same reference numerals refer to the same elements. The drawings may not be to scale, and the relative size, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that would be well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will fully convey the scope of the disclosure to one of ordinary skill in the art.

Herein, it is noted that use of the term “may” with respect to an example or embodiment, e.g., as to what an example or embodiment may include or implement, means that at least one example or embodiment exists in which such a feature is included or implemented while all examples and embodiments are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

The drawings may not be to scale, and the relative sizes, proportions, and depiction of elements in the drawings may be exaggerated for clarity, illustration, and convenience.

In the diagrams illustrating the lenses, a thickness, a size, and a shape of the lens are exaggerated to illustrate an example, and a spherical or an aspherical shape of the lens illustrated in the diagram is an example, and a shape is not limited thereto.

The first lens refers to the lens most adjacent to an object side, and the eighth lens refers to the lens most adjacent to an imaging plane (or an image sensor).

Also, in each lens, the first surface refers to a surface adjacent to an object side (or an object-side surface), and the second surface refers to a surface adjacent to an image side (or an image-side surface). Also, in each example, units of numerical values for a radius of curvature, thickness, distance, focal length, or the like of the lens are millimeters, and a unit of a field of view (FOV) is degrees.

Also, in the descriptions of the shape of each lens, the notion in which one surface is convex indicates that a paraxial region of the surface is convex, the notion in which one surface is concave indicates that a paraxial region of the surface is concave, and the notion that one surface is planar indicates that a paraxial region of the surface is planar. Therefore, even when it is described that one surface of the lens is convex, an edge portion of the lens may be concave. Similarly, even when it is described that one surface of the lens is concave, an edge portion of the lens may be convex. Also, when it is described that one surface of the lens is planar, an edge portion of the lens may be convex or concave.

The paraxial region refers to a relatively narrow region neighboring to an optical axis.

The imaging plane may refer to a virtual plane on which a focus may be formed by an optical imaging system. Alternatively, the imaging plane may refer to one surface of the image sensor on which light is received.

The optical imaging system in various examples may include eight lenses.

For example, the optical system may include a first lens, a second lens, a third lens, a fourth lens, a fifth lens, a sixth lens, a seventh lens, and an eighth lens disposed in order from an object side. The first to eighth lenses may be spaced apart from each other by a predetermined distance along the optical axis.

However, the optical imaging system may not simply include eight lenses, and may further include other components if desired.

For example, the optical imaging system may further include an image sensor for converting an incident image of a subject into an electrical signal.

Also, the optical imaging system may further include an infrared filter (hereinafter, referred to as a “filter”) for blocking infrared rays. The filter may be disposed between the eighth lens and the image sensor.

Also, the optical imaging system may further include a stop for adjusting the amount of incident light.

The first to eighth lenses included in the optical imaging system may be formed of a plastic material.

Also, at least one of the first to eighth lenses has an aspherical surface. Also, each of the first to eighth lenses may have at least one aspherical surface.

That is, at least one of the first and second surfaces of the first to eighth lenses may be aspherical. Here, the aspherical surfaces of the first to eighth lenses are represented by Equation 1.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} … \qquad [ Equation 1 ]$$

In Equation 1, c is a radius of curvature of the lens (a reciprocal of a radius of curvature), K is a conic constant, and Y is a distance from one point on the aspherical surface of the lens to the optical axis. Also, constants A to P refer to aspheric coefficients. Z is a distance between one point on the aspherical surface of the lens and an apex of the aspherical surface in an optical axis direction.

The optical imaging system in the various examples may satisfy at least one of following conditional expressions:

$$0 < f 1 / f < 1.5 \qquad [ Conditional Expression 1 ]$$

$$25 < v 1 - v 2 < 45 \qquad [ Conditional Expression 2 ]$$

$$25 < v 1 - v 4 < 45 \qquad [ Conditional Expression 3 ]$$

$$0 \leq v 1 - v 6 < 25 \qquad [ Conditional Expression 4 ]$$

$$- 5 < f 2 / f < - 1 \qquad [ Conditional Expression 5 ]$$

$$- 10 < f 3 / f / 100 < 2 \qquad [ Conditional Expression 6 ]$$

$$- 5 < f 4 / f / 100 < 1 \qquad [ Conditional Expression 7 ]$$

$$- 3 < f 5 / f / 100 < 3 \qquad [ Conditional Expression 8 ]$$

$$- 50 < f 6 < 10 \qquad [ Conditional Expression 9 ]$$

$$- 5 < f 7 / f < 0 \qquad [ Conditional Expression 10 ]$$

$$TTL / f < 1.3 \qquad [ Conditional Expression 11 ]$$

$$- 0.5 < f 1 / f 2 < 0 \qquad [ Conditional Expression 12 ]$$

$$- 1 < f 1 / f 3 < 3 \qquad [ Conditional Expression 13 ]$$

$$BFL / f < 0.3 \qquad [ Conditional Expression 14 ]$$

$$D 1 / f < 0.3 \qquad [ Conditional Expression 15 ]$$

$$TTL / ( 2 \times IMG HT ) < 0.62 \qquad [ Conditional Expression 16 ]$$

$$70 ° < FOV \times ( IMG HT / f ) \qquad [ Conditional Expression 17 ]$$

$$1.5 < f / EPD < 2.3 \qquad [ Conditional Expression 18 ]$$

$$2 < CT 1 / ET 1 < 5 \qquad [ Conditional Expression 19 ]$$

$$\vert f 1 / f 2 / n 2 \vert < 0.3 \qquad [ Conditional Expression 20 ]$$

$$\vert f 1 / f 4 / n 4 \vert < 0.3 \qquad [ Conditional Expression 21 ]$$

$$SWA 71 < 30 ° \qquad [ Conditional Expression 22 ]$$

$$SWA 72 < 42 ° \qquad [ Conditional Expression 23 ]$$

$$v 2 + v 4 < v 3 \qquad [ Conditional Expression 24 ]$$

$$v 2 + v 4 < v 1 \qquad [ Conditional Expression 25 ]$$

$$4.9 < n 2 + n 4 + n 5 < 5.2 \qquad [ Conditional Expression 26 ]$$

In the conditional expressions, f is a total focal length of the optical imaging system, f1is the focal length of the first lens, f2 is the focal length of the second lens, f3 is the focal length of the third lens, f4 is the focal length of the fourth lens, f5 is the focal length of the fifth lens, f6 is the focal length of the sixth lens, f7 is the focal length of the seventh lens, f8 is the focal length of the eighth lens, and f34 is the combined focal length of the third and fourth lenses.

In the conditional expressions, v1 is an Abbe number of the first lens, v2 is an Abbe number of the second lens, v3 is an Abbe number of the third lens, v4 is an Abbe number of the fourth lens, v5 is an Abbe number of the fifth lens, v6 is an Abbe number of the sixth lens, and v7 is an Abbe number of the seventh lens.

In the conditional expressions, TTL is a distance from the object-side surface of the first lens to an imaging plane on an optical axis, BFL is the distance from the image-side surface of the eighth lens to the imaging plane on an optical axis, D1 is the distance between the image-side surface of the first lens and the object-side surface of the second lens on the optical axis, and D3 is the distance between the image-side surface of the third lens and the object-side surface of the fourth lens on the optical axis.

In the conditional expressions, IMG HT is half the diagonal length of the imaging surface, and FOV is the field of view of the optical imaging system.

The first lens may have positive refractive power. Also, the first lens may have a meniscus shape convex toward the object. In greater detail, the first surface of the first lens may be convex, and the second surface of the first lens may be concave.

At least one of the first surface and the second surface of the first lens may be aspherical. For example, both surfaces of the first lens may be aspherical.

The second lens may have negative refractive power. Also, the second lens may have a meniscus shape convex toward the object side. In greater detail, the first surface of the second lens may be convex, and the second surface of the second lens may be concave.

At least one of the first surface and the second surface of the second lens may be aspherical. For example, both surfaces of the second lens may be aspherical.

The third lens may have positive or negative refractive power. Also, the third lens may have a meniscus shape convex toward the object. In greater detail, the first surface of the third lens may be convex and the second surface of the third lens may be concave.

At least one of the first surface and the second surface of the third lens may be aspherical. For example, both surfaces of the third lens may be aspherical.

The fourth lens may have negative refractive power. Also, the fourth lens may have a meniscus shape convex toward the object side. In greater detail, the first surface of the fourth lens may be concave, and the second surface of the fourth lens may be convex.

Alternatively, the fourth lens may have a meniscus shape convex toward the image side. In greater detail, the first surface of the fourth lens may be convex, and the second surface of the fourth lens may be concave.

Alternatively, both surfaces of the fourth lens may be convex. In greater detail, the first surface and the second surface of the fourth lens may be convex.

At least one of the first surface and the second surface of the fourth lens may be aspherical. For example, both surfaces of the fourth lens may be aspherical.

The fifth lens may have negative refractive power. Also, the fifth lens may have a meniscus shape convex toward the object. In greater detail, the first surface of the fifth lens may be convex in the paraxial region, and a second surface of the fifth lens may be concave in the paraxial region.

Alternatively, the fifth lens may have a meniscus shape convex toward the image. In greater detail, the first surface of the fifth lens may be concave, and the second surface of the fifth lens may be convex.

Alternatively, both surfaces of the fifth lens may be concave. In greater detail, the first surface and the second surface of the fifth lens may be concave.

At least one of the first surface and the second surface of the fifth lens may be aspherical. For example, both surfaces of the fifth lens may be aspherical.

The sixth lens may have positive refractive power or negative refractive power. Also, the sixth lens may have a meniscus shape convex toward the object side. In greater detail, the first surface of the sixth lens may be convex in the paraxial region, and the second surface of the sixth lens may be concave in the paraxial region.

At least one of the first surface and the second surface of the sixth lens may be aspherical. For example, both surfaces of the sixth lens may be aspherical.

The sixth lens may have at least one inflection point formed on at least one of the first surface and the second surface. For example, the first surface of the sixth lens may be convex in the paraxial region and may be concave in a portion other than the paraxial region. The second surface of the sixth lens may be concave in the paraxial region and may be convex in a portion other than the paraxial region.

The seventh lens may have positive refractive power. Also, the seventh lens may have a meniscus shape convex toward the object side. In greater detail, the first surface of the seventh lens may be convex in the paraxial region, and the second surface of the seventh lens may be concave in the paraxial region.

Alternatively, both surfaces of the seventh lens may be convex. In greater detail, the first surface and the second surface of the seventh lens may be convex.

At least one of the first surface and the second surface of the seventh lens may be aspherical. For example, both surfaces of the seventh lens may be aspherical.

Also, at least one inflection point may be formed on at least one of the first surface and the second surface of the seventh lens. For example, the first surface of the seventh lens may be convex in the paraxial region and may be concave in a portion other than the paraxial region. The second surface of the seventh lens may be concave in the paraxial region and may be convex in a portion other than the paraxial region.

The eighth lens may have negative refractive power. Also, the eighth lens may have a meniscus shape convex toward the object-side surface. In greater detail, the first surface of the eighth lens may be convex in the paraxial region, and the second surface of the eighth lens may be concave in the paraxial region.

Alternatively, both surfaces of the eighth lens may be concave. In greater detail, the first surface and the second surface of the eighth lens may be concave.

At least one of the first and second surfaces of the eighth lens may be aspherical. For example, both surfaces of the eighth lens may be aspherical.

Also, in the eighth lens, at least one inflection point may be formed on at least one of the first surface and the second surface. For example, the first surface of the eighth lens may be convex in the paraxial region and may be concave in a portion other than the paraxial region. The second surface of the eighth lens may be concave in the paraxial region and may be convex in a portion other than the paraxial region.

Each of the first to third lenses may be configured to have a refractive index different from those of the adjacent lenses. For example, the first lens and the second lens have different refractive indices, and the second and third lenses may have different refractive indices. Also, the refractive index of the second lens may be the largest among the first to third lenses.

At least three lenses including the second lens among the first to eighth lenses may have a refractive index greater than 1.61. For example, the refractive index of the second lens, the fifth lens, and the sixth lens may be greater than 1.61. Also, the refractive index of the second lens and the fifth lens may be greater than 1.66.

Among lenses having a refractive index greater than 1.61, the absolute value of the focal length of the second lens may be the lowest.

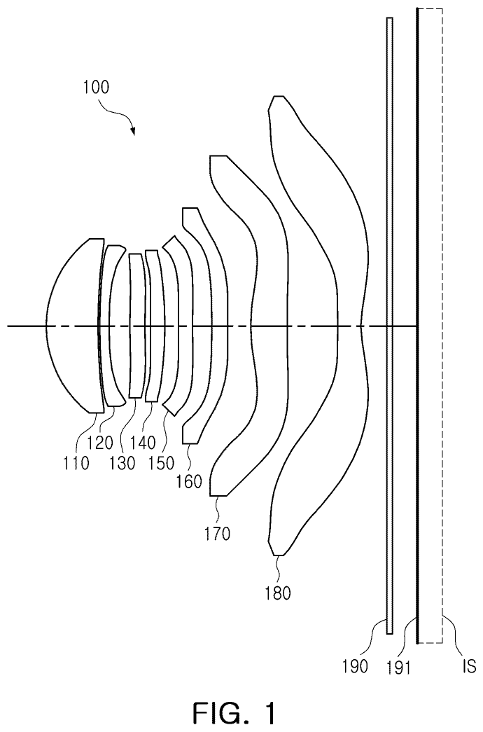

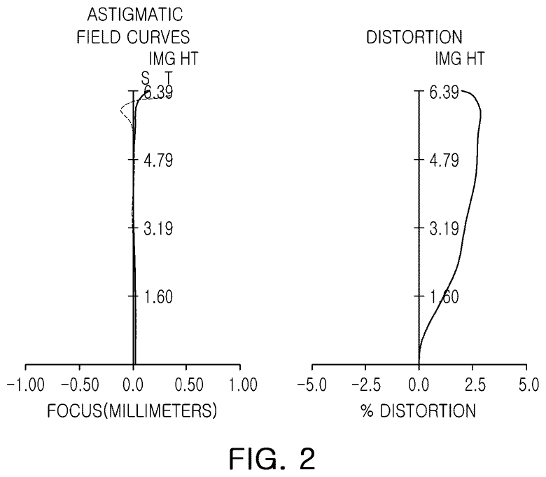

An optical imaging system 100 according to a first example will be described with reference to FIGS. 1 and 2.

The optical imaging system 100 may include an optical system including a first lens 110, a second lens 120, a third lens 130, a fourth lens 140, a fifth lens 150, a sixth lens 160, a seventh lens 170, and an eighth lens 180 and may further include a filter 190 and an image sensor IS.

The optical imaging system 100 may form a focus on the imaging plane 191. The imaging plane 191 may refer to a surface on which a focus may be formed by the optical imaging system. For example, the imaging plane 191 may refer to one surface of the image sensor IS on which light is received.

The lens characteristics of each lens (a radius of curvature, a thickness of the lens or a distance between the lenses, a refractive index, an Abbe number, and a focal length) are listed in Table 1.

TABLE 1

| Surface | | Radius of | Thickness | Refractive | Abbe | Focal |
|---|---|---|---|---|---|---|
| No. | Elements | curvature | or distance | index | number | length |
| S1 | First lens | 2.341 | 0.983 | 1.544 | 56.0 | 5.0728 |
| S2 | | 12.838 | 0.027 | | | |
| S3 | Second lens | 12.240 | 0.180 | 1.661 | 20.4 | −13.0719 |
| S4 | | 5.068 | 0.404 | | | |
| S5 | Third lens | 12.224 | 0.299 | 1.544 | 56.0 | −624.5040 |
| S6 | | 11.699 | 0.112 | | | |
| S7 | Fourth lens | −20.435 | 0.268 | 1.544 | 56.0 | 25.0632 |
| S8 | | −8.237 | 0.262 | | | |
| S9 | Fifth lens | 32.907 | 0.264 | 1.661 | 20.4 | −27.0116 |
| S10 | | 11.620 | 0.376 | | | |
| S11 | Sixth lens | 25.778 | 0.300 | 1.614 | 25.9 | −38.1170 |
| S12 | | 12.275 | 0.450 | | | |
| S13 | Seventh lens | 4.008 | 0.700 | 1.567 | 37.4 | 8.0248 |
| S14 | | 30.082 | 0.970 | | | |
| S15 | Eighth lens | 12.084 | 0.452 | 1.535 | 55.7 | −5.1562 |
| S16 | | 2.224 | 0.500 | | | |
| S17 | Filter | Infinity | 0.110 | 1.517 | 64.2 | |
| S18 | | Infinity | 0.432 | | | |
| S19 | Imaging plane | Infinity | | | | |

The total focal length f of the optical imaging system 100 may be 6.3132 mm, IMG HT may be 6.12 mm, and FOV may be 85.3°.

In the first example, the first lens 110 may have positive refractive power, the first surface of the first lens 110 may be convex, and the second surface of the first lens 110 may be concave.

The second lens 120 may have negative refractive power, a first surface of the second lens 120 may be convex, and a second surface of the second lens 120 may be concave.

The third lens 130 may have negative refractive power, the first surface of the third lens 130 may be convex, and a second surface of the third lens 130 may be concave.

The fourth lens 140 may have positive refractive power, the first surface of the fourth lens 140 may be concave, and the second surface of the fourth lens 140 may be convex.

The fifth lens 150 may have negative refractive power, the first surface of the fifth lens 150 may be concave, and the second surface of the fifth lens 150 may be convex.

The sixth lens 160 may have negative refractive power, the first surface of the sixth lens 160 may be convex in the paraxial region, and the second surface of the sixth lens 160 may be concave in the paraxial region.

Also, at least one inflection point may be formed on at least one of the first and second surfaces of the sixth lens 160. For example, the first surface of the sixth lens 160 may be convex in the paraxial region and may be concave in a portion other than the paraxial region. Also, the second surface of the sixth lens 160 may be concave in the paraxial region and may be convex in a portion other than the paraxial region.

The seventh lens 170 may have positive refractive power, the first surface of the seventh lens 170 may be convex in the paraxial region, and the second surface of the seventh lens 170 may be concave in the paraxial region.

Also, at least one inflection point may be formed on at least one of the first and second surfaces of the seventh lens 170. For example, the first surface of the seventh lens 170 may be convex in the paraxial region and may be concave in a portion other than the paraxial region. Also, the second surface of the seventh lens 170 may be concave in the paraxial region and may be convex in a portion other than the paraxial region.

The eighth lens 180 may have negative refractive power, the first surface of the eighth lens 180 may be convex in the paraxial region, and the second surface of the eighth lens 180 may be concave in the paraxial region.

Also, at least one inflection point may be formed on at least one of the first and second surfaces of the eighth lens 180. For example, the first surface of the eighth lens 180 may be convex in the paraxial region and may be concave in a portion other than the paraxial region. Also, the second surface of the eighth lens 180 may be concave in the paraxial region and may be convex in a portion other than the paraxial region.

Each surface of the first lens 110 to the eighth lens 180 may have an aspherical coefficient as in Table 2. For example, both the object-side surface and the image-side surface of the first lens 110 to the eighth lens 180 may be aspherical.

TABLE 2

| | S1 | S2 | S3 | S4 | S5 | S6 | S7 | S8 |
|---|---|---|---|---|---|---|---|---|
| Conic | −0.438 | 4.688 | 21.802 | 4.178 | −81.344 | −62.814 | 80.875 | −14.745 |
| constant (K) | | | | | | | | |
| 4th order | 4.137E−03 | −1.561E−04 | −5.478E−03 | −3.187E−03 | −1.970E−02 | −2.648E−02 | 1.157E−02 | 1.483E−03 |
| coefficient(A) | | | | | | | | |
| 6th order | 7.051E−03 | −7.109E−03 | 1.240E−02 | −9.100E−03 | −2.427E−02 | −1.821E−03 | −1.077E−01 | −4.866E−02 |
| coefficient(B) | | | | | | | | |
| 8th order | −2.521E−02 | 2.731E−02 | −6.439E−02 | 5.252E−02 | −5.699E−03 | −4.303E−02 | 6.241E−01 | 3.291E−01 |
| coefficient(C) | | | | | | | | |
| 10th order | 6.932E−02 | −1.155E−01 | 2.075E−01 | −9.331E−02 | 4.289E−01 | −1.054E−01 | −2.751E+00 | −1.399E+00 |
| coefficient(D) | | | | | | | | |
| 12th order | −1.284E−01 | 3.693E−01 | −3.778E−01 | −5.530E−02 | −2.053E+00 | 1.115E+00 | 8.159E+00 | 3.919E+00 |
| coefficient(E) | | | | | | | | |
| 14th order | 1.664E−01 | −7.377E−01 | 4.378E−01 | 6.631E−01 | 5.385E+00 | −3.645E+00 | −1.671E+01 | −7.494E+00 |
| coefficient(F) | | | | | | | | |
| 16th order | −1.542E−01 | 9.540E−01 | −3.432E−01 | −1.607E+00 | −9.144E+00 | 6.965E+00 | 2.424E+01 | 1.007E+01 |
| coefficient(G) | | | | | | | | |
| 18th order | 1.035E−01 | −8.338E−01 | 1.896E−01 | 2.214E+00 | 1.065E+01 | −8.766E+00 | −2.521E+01 | −9.659E+00 |
| coefficient(H) | | | | | | | | |
| 20th order | −5.037E−02 | 5.043E−01 | −7.674E−02 | −1.983E+00 | −8.681E+00 | 7.569E+00 | 1.885E+01 | 6.642E+00 |
| coefficient(J) | | | | | | | | |
| 22nd order | 1.759E−02 | −2.120E−01 | 2.381E−02 | 1.196E+00 | 4.958E+00 | −4.524E+00 | −1.004E+01 | −3.247E+00 |
| coefficient(L) | | | | | | | | |
| 24th order | −4.291E−03 | 6.093E−02 | −5.861E−03 | −4.832E−01 | −1.944E+00 | 1.843E+00 | 3.715E+00 | 1.101E+00 |
| coefficient(M) | | | | | | | | |
| 26th order | 6.936E−04 | −1.144E−02 | 1.110E−03 | 1.256E−01 | 4.988E−01 | −4.888E−01 | −9.071E−01 | −2.459E−01 |
| coefficient(N) | | | | | | | | |
| 28th order | −6.668E−05 | 1.265E−03 | −1.399E−04 | −1.899E−02 | −7.540E−02 | 7.615E−02 | 1.314E−01 | 3.255E−02 |
| coefficient(O) | | | | | | | | |
| 30th order | 2.884E−06 | −6.258E−05 | 8.391E−06 | 1.269E−03 | 5.091E−03 | −5.288E−03 | −8.548E−03 | −1.932E−03 |
| coefficient(P) | | | | | | | | |
| | S9 | S10 | S11 | S12 | S13 | S14 | S15 | S16 |
| Conic | −99.000 | −30.923 | 99.000 | −9.158 | −18.560 | 22.570 | −1.662 | −10.621 |
| constant (K) | | | | | | | | |
| 4th order | −4.155E−02 | −4.369E−02 | −1.068E−01 | −1.406E−01 | −1.334E−02 | −1.605E−03 | −1.541E−01 | −7.001E−02 |
| coefficient(A) | | | | | | | | |
| 6th order | −2.883E−02 | 1.983E−02 | 1.608E−01 | 1.511E−01 | −1.973E−03 | 5.621E−03 | 8.246E−02 | 3.287E−02 |
| coefficient(B) | | | | | | | | |
| 8th order | 1.739E−01 | −6.236E−03 | −2.813E−01 | −1.957E−01 | 7.883E−04 | −9.808E−03 | −3.505E−02 | −1.230E−02 |
| coefficient(C) | | | | | | | | |
| 10th order | −6.071E−01 | −9.935E−02 | 4.181E−01 | 2.231E−01 | −3.258E−03 | 6.032E−03 | 1.094E−02 | 3.413E−03 |
| coefficient(D) | | | | | | | | |
| 12th order | 1.313E+00 | 3.076E−01 | −4.836E−01 | −1.995E−01 | 3.448E−03 | −2.411E−03 | −2.420E−03 | −7.102E−04 |
| coefficient(E) | | | | | | | | |
| 14th order | −1.867E+00 | −5.035E−01 | 4.192E−01 | 1.344E−01 | −2.012E−03 | 7.065E−04 | 3.837E−04 | 1.124E−04 |
| coefficient(F) | | | | | | | | |
| 16th order | 1.802E+00 | 5.400E−01 | −2.705E−01 | −6.741E−02 | 7.594E−04 | −1.586E−04 | −4.427E−05 | −1.361E−05 |
| coefficient(G) | | | | | | | | |
| 18th order | −1.184E+00 | −4.045E−01 | 1.296E−01 | 2.496E−02 | −1.975E−04 | 2.758E−05 | 3.749E−06 | 1.254E−06 |
| coefficient(H) | | | | | | | | |
| 20th order | 5.121E−01 | 2.159E−01 | −4.566E−02 | −6.740E−03 | 3.624E−05 | −3.682E−06 | −2.329E−07 | −8.710E−08 |
| coefficient(J) | | | | | | | | |
| 22nd order | −1.296E−01 | −8.189E−02 | 1.164E−02 | 1.303E−03 | −4.680E−06 | 3.683E−07 | 1.048E−08 | 4.464E−09 |
| coefficient(L) | | | | | | | | |
| 24th order | 9.751E−03 | 2.159E−02 | −2.079E−03 | −1.746E−04 | 4.148E−07 | −2.650E−08 | −3.325E−10 | −1.632E−10 |
| coefficient(M) | | | | | | | | |
| 26th order | 4.340E−03 | −3.761E−03 | 2.459E−04 | 1.536E−05 | −2.394E−08 | 1.286E−09 | 7.051E−12 | 4.011E−12 |
| coefficient(N) | | | | | | | | |
| 28th order | −1.329E−03 | 3.891E−04 | −1.721E−05 | −7.950E−07 | 8.080E−10 | −3.746E−11 | −8.964E−14 | −5.927E−14 |
| coefficient(O) | | | | | | | | |
| 30th order | 1.190E−04 | −1.810E−05 | 5.364E−07 | 1.831E−08 | −1.208E−11 | 4.915E−13 | 5.167E−16 | 3.968E−16 |
| coefficient(P) | | | | | | | | |

Also, the optical imaging system 100 may have the aberration characteristics illustrated in FIG. 2.

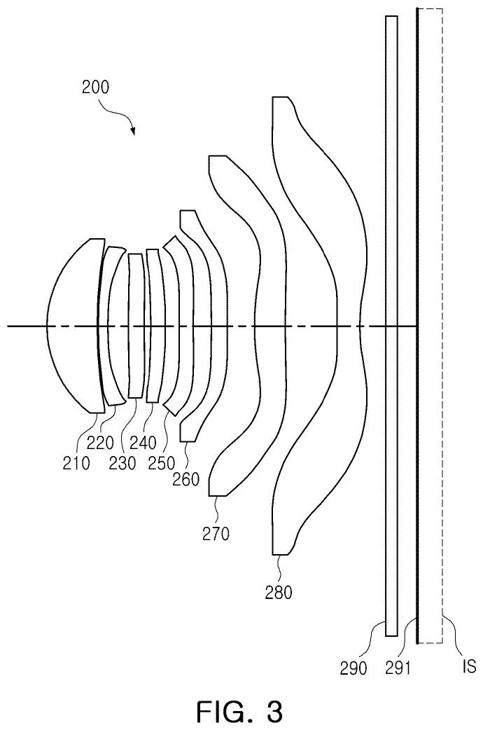

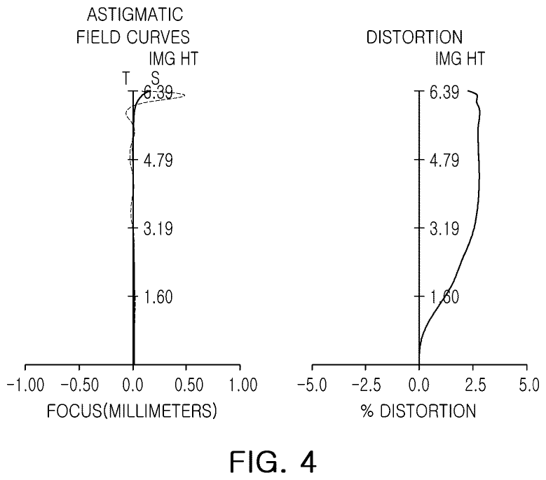

An optical imaging system 200 according to a second example will be described with reference to FIGS. 3 and 4.

The optical imaging system 200 may include an optical system including a first lens 210, a second lens 220, a third lens 230, a fourth lens 240, a fifth lens 250, a sixth lens 260, a seventh lens 270, and an eighth lens 280 and may further include a filter 290 and an image sensor IS.

The optical imaging system 200 may form a focus on the imaging plane 291. The imaging plane 291 may refer to a surface on which a focus may be formed by the optical imaging system. For example, the imaging plane 291 may refer to one surface of the image sensor IS on which light is received.

The lens characteristics of each lens (a radius of curvature, a thickness of the lens or a distance between the lenses, a refractive index, an Abbe number, and a focal length) are listed in Table 3.

TABLE 3

| Surface | | Radius of | Thickness | Refractive | Abbe | Focal |
|---|---|---|---|---|---|---|
| No. | Elements | curvature | or distance | index | number | length |
| S1 | First lens | 2.331 | 0.962 | 1.544 | 56.0 | 5.1546 |
| S2 | | 11.551 | 0.024 | | | |
| S3 | Second lens | 10.407 | 0.180 | 1.661 | 20.4 | −12.6836 |
| S4 | | 4.639 | 0.388 | | | |
| S5 | Third lens | 9.642 | 0.306 | 1.544 | 56.0 | 142.2645 |
| S6 | | 10.884 | 0.134 | | | |
| S7 | Fourth lens | −22.378 | 0.289 | 1.544 | 56.0 | 27.5069 |
| S8 | | −9.031 | 0.247 | | | |
| S9 | Fifth lens | 39.840 | 0.271 | 1.661 | 20.4 | −25.5095 |
| S10 | | 11.907 | 0.359 | | | |
| S11 | Sixth lens | 18.009 | 0.309 | 1.614 | 25.9 | −93.5504 |
| S12 | | 13.652 | 0.527 | | | |
| S13 | Seventh lens | 4.060 | 0.579 | 1.567 | 37.4 | 8.6488 |
| S14 | | 21.686 | 1.012 | | | |
| S15 | Eighth lens | 14.304 | 0.430 | 1.535 | 55.7 | −5.0177 |
| S16 | | 2.244 | 0.500 | | | |
| S17 | Filter | Infinity | 0.210 | 1.517 | 64.2 | |
| S18 | | Infinity | 0.363 | | | |
| S19 | Imaging plane | Infinity | | | | |

The total focal length f of the optical imaging system 200 may be 6.3083 mm, IMG HT may be 6.12 mm, and FOV may be 85.3°.

In the second example, the first lens 210 may have positive refractive power, the first surface of the first lens 210 may be convex, and the second surface of the first lens 210 may be concave.

The second lens 220 may have negative refractive power, the first surface of the second lens 220 may be convex, and the second surface of the second lens 220 may be concave.

The third lens 230 may have positive refractive power, the first surface of the third lens 230 may be convex, and a second surface of the third lens 230 may be concave.

The fourth lens 240 may have positive refractive power, the first surface of the fourth lens 240 may be concave, and the second surface of the fourth lens 240 may be convex.

The fifth lens 250 may have negative refractive power, the first surface of the fifth lens 250 may be convex, and the second surface of the fifth lens 250 may be concave. The sixth lens 260 may have negative refractive power, the first surface of the sixth lens 260 may be convex in the paraxial region, and the second surface of the sixth lens 260 may be concave in the paraxial region.

Also, at least one inflection point may be formed on at least one of the first and second surfaces of the sixth lens 260. For example, the first surface of the sixth lens 260 may be convex in the paraxial region and may be concave in a portion other than the paraxial region. Also, the second surface of the sixth lens 260 may be concave in the paraxial region and may be convex in a portion other than the paraxial region.

The seventh lens 270 may have positive refractive power, the first surface of the seventh lens 270 may be convex in the paraxial region, and the second surface of the seventh lens 270 may be concave in the paraxial region.

Also, at least one inflection point may be formed on at least one of the first and second surfaces of the seventh lens 270. For example, the first surface of the seventh lens 270 may be convex in the paraxial region and may be concave in a portion other than the paraxial region. Also, the second surface of the seventh lens 270 may be concave in the paraxial region and may be convex in a portion other than the paraxial region.

The eighth lens 280 may have negative refractive power, the first surface of the eighth lens 280 may be convex in the paraxial region, and the second surface of the eighth lens 280 may be concave in the paraxial region.

Also, at least one inflection point may be formed on at least one of the first and second surfaces of the eighth lens 280. For example, the first surface of the eighth lens 280 may be convex in the paraxial region and may be concave in a portion other than the paraxial region. Also, the second surface of the eighth lens 280 may be concave in the paraxial region and may be convex in a portion other than the paraxial region.

Each surface of the first lens 210 to the eighth lens 280 may have an aspherical coefficient as in Table 4. For example, both the object-side surface and the image-side surface of the first lens 210 to the eighth lens 280 may be aspherical.

TABLE 4

| | S1 | S2 | S3 | S4 | S5 | S6 | S7 | S8 |
|---|---|---|---|---|---|---|---|---|
| Conic | −0.420 | 11.521 | 19.698 | 3.908 | −31.102 | −16.023 | 99.000 | −3.637 |
| constant (K) | | | | | | | | |
| 4th order | 1.871E−03 | 1.644E−02 | 1.053E−02 | 2.250E−04 | −1.600E−02 | −2.991E−02 | 3.275E−03 | 4.069E−03 |
| coefficient(A) | | | | | | | | |
| 6th order | 2.250E−02 | −5.344E−02 | −4.237E−02 | −4.080E−02 | −6.155E−02 | 2.645E−02 | −3.325E−02 | −3.825E−02 |
| coefficient(B) | | | | | | | | |
| 8th order | −8.263E−02 | 1.425E−01 | 8.687E−02 | 2.185E−01 | 3.585E−01 | −2.284E−01 | 3.947E−02 | 2.087E−01 |
| coefficient(C) | | | | | | | | |
| 10th order | 2.080E−01 | −4.153E−01 | −2.141E−01 | −7.802E−01 | −1.466E+00 | 7.317E−01 | −4.028E−02 | −8.729E−01 |
| coefficient(D) | | | | | | | | |
| 12th order | −3.586E−01 | 9.374E−01 | 4.911E−01 | 1.959E+00 | 4.081E+00 | −1.419E+00 | 3.901E−02 | 2.428E+00 |
| coefficient(E) | | | | | | | | |
| 14th order | 4.372E−01 | −1.455E+00 | −7.889E−01 | −3.485E+00 | −7.907E+00 | 1.756E+00 | −6.812E−02 | −4.576E+00 |
| coefficient(F) | | | | | | | | |
| 16th order | −3.834E−01 | 1.569E+00 | 8.724E−01 | 4.488E+00 | 1.093E+01 | −1.273E+00 | 1.833E−01 | 6.034E+00 |
| coefficient(G) | | | | | | | | |
| 18th order | 2.440E−01 | −1.200E+00 | −6.796E−01 | −4.241E+00 | −1.092E+01 | 2.770E−01 | −3.280E−01 | −5.671E+00 |
| coefficient(H) | | | | | | | | |
| 20th order | −1.125E−01 | 6.573E−01 | 3.778E−01 | 2.946E+00 | 7.912E+00 | 4.323E−01 | 3.586E−01 | 3.818E+00 |
| coefficient(J) | | | | | | | | |
| 22nd order | 3.717E−02 | −2.561E−01 | −1.495E−01 | −1.489E+00 | −4.117E+00 | −5.166E−01 | −2.497E−01 | −1.826E+00 |
| coefficient(L) | | | | | | | | |
| 24th order | −8.557E−03 | 6.942E−02 | 4.124E−02 | 5.331E−01 | 1.499E+00 | 2.824E−01 | 1.123E−01 | 6.053E−01 |
| coefficient(M) | | | | | | | | |
| 26th order | 1.302E−03 | −1.244E−02 | −7.559E−03 | −1.282E−01 | −3.627E−01 | −8.854E−02 | −3.168E−02 | −1.321E−01 |
| coefficient(N) | | | | | | | | |
| 28th order | −1.176E−04 | 1.327E−03 | 8.293E−04 | 1.857E−02 | 5.237E−02 | 1.535E−02 | 5.114E−03 | 1.707E−02 |
| coefficient(O) | | | | | | | | |
| 30th order | 4.767E−06 | −6.380E−05 | −4.134E−05 | −1.226E−03 | −3.417E−03 | −1.147E−03 | −3.606E−04 | −9.883E−04 |
| coefficient(P) | | | | | | | | |
| | S9 | S10 | S11 | S12 | S13 | S14 | S15 | S16 |
| Conic | −85.385 | −27.350 | 72.351 | −90.031 | −23.471 | −29.037 | 2.453 | −11.313 |
| constant (K) | | | | | | | | |
| 4th order | −3.544E−02 | −4.055E−02 | −9.165E−02 | −1.219E−01 | −2.002E−03 | −5.520E−03 | −1.655E−01 | −7.435E−02 |
| coefficient(A) | | | | | | | | |
| 6th order | −1.012E−02 | 1.008E−02 | 3.988E−02 | 1.071E−01 | −1.179E−02 | 6.784E−03 | 9.656E−02 | 3.827E−02 |
| coefficient(B) | | | | | | | | |
| 8th order | 5.055E−02 | 8.319E−02 | 1.455E−01 | −1.097E−01 | 1.041E−03 | −1.452E−02 | −4.829E−02 | −1.590E−02 |
| coefficient(C) | | | | | | | | |
| 10th order | −1.556E−01 | −4.405E−01 | −5.761E−01 | 9.030E−02 | 3.656E−03 | 1.148E−02 | 1.826E−02 | 4.864E−03 |
| coefficient(D) | | | | | | | | |
| 12th order | 1.825E−01 | 1.072E+00 | 1.107E+00 | −4.413E−02 | −3.430E−03 | −5.519E−03 | −4.866E−03 | −1.083E−03 |
| coefficient(E) | | | | | | | | |
| 14th order | 1.205E−01 | −1.634E+00 | −1.373E+00 | 8.413E−05 | 1.684E−03 | 1.804E−03 | 9.170E−04 | 1.776E−04 |
| coefficient(F) | | | | | | | | |
| 16th order | −6.978E−01 | 1.698E+00 | 1.175E+00 | 1.675E−02 | −5.341E−04 | −4.194E−04 | −1.243E−04 | −2.172E−05 |
| coefficient(G) | | | | | | | | |
| 18th order | 1.089E+00 | −1.244E+00 | −7.124E−01 | −1.291E−02 | 1.124E−04 | 7.044E−05 | 1.225E−05 | 1.993E−06 |
| coefficient(H) | | | | | | | | |
| 20th order | −9.823E−01 | 6.495E−01 | 3.086E−01 | 5.405E−03 | −1.519E−05 | −8.514E−06 | −8.802E−07 | −1.367E−07 |
| coefficient(J) | | | | | | | | |
| 22nd order | 5.732E−01 | −2.406E−01 | −9.482E−02 | −1.434E−03 | 1.200E−06 | 7.281E−07 | 4.565E−08 | 6.894E−09 |
| coefficient(L) | | | | | | | | |
| 24th order | −2.202E−01 | 6.176E−02 | 2.018E−02 | 2.472E−04 | −3.745E−08 | −4.261E−08 | −1.666E−09 | −2.478E−10 |
| coefficient(M) | | | | | | | | |
| 26th order | 5.403E−02 | −1.045E−02 | −2.828E−03 | −2.690E−05 | −1.720E−09 | 1.607E−09 | 4.059E−11 | 5.990E−12 |
| coefficient(N) | | | | | | | | |
| 28th order | −7.690E−03 | 1.047E−03 | 2.345E−04 | 1.682E−06 | 1.829E−10 | −3.468E−11 | −5.931E−13 | −8.708E−14 |
| coefficient(O) | | | | | | | | |
| 30th order | 4.840E−04 | −4.709E−05 | −8.715E−06 | −4.614E−08 | −4.503E−12 | 3.183E−13 | 3.930E−15 | 5.738E−16 |
| coefficient(P) | | | | | | | | |

Also, the optical imaging system 200 may have the aberration characteristics illustrated in FIG. 4.

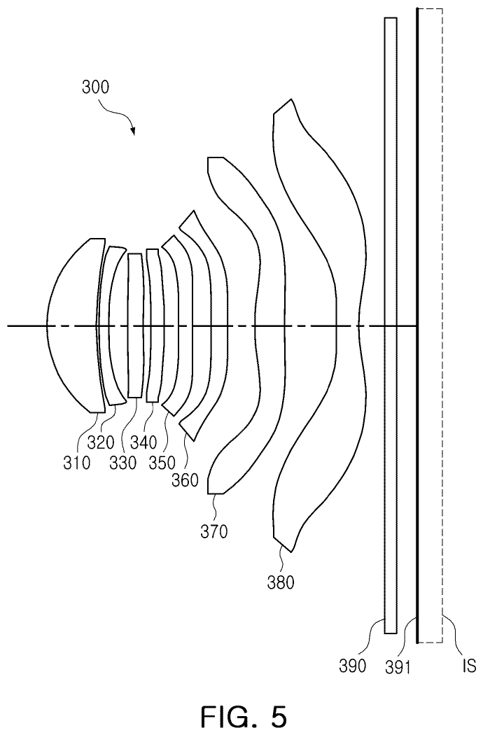

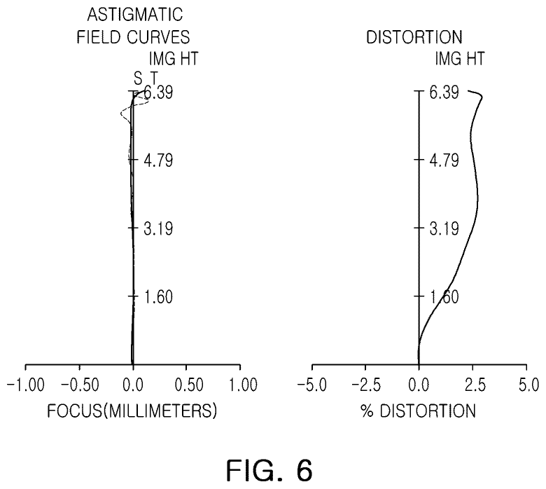

An optical imaging system 300 according to a third example will be described with reference to FIGS. 5 and 6.

The optical imaging system 300 may include an optical system including a first lens 310, a second lens 320, a third lens 330, a fourth lens 340, a fifth lens 350, a sixth lens 360, a seventh lens 370, and an eighth lens 380 and may further include a filter 390 and an image sensor IS.

The optical imaging system 300 may form a focus on the imaging plane 391. The imaging plane 391 may refer to a surface on which a focus may be formed by the optical imaging system. For example, the imaging plane 391 may refer to one surface of the image sensor IS on which light is received.

The lens characteristics of each lens (a radius of curvature, a thickness of the lens or a distance between the lenses, a refractive index, an Abbe number, and a focal length) are listed in Table 5.

TABLE 5

| Surface | | Radius of | Thickness | Refractive | Abbe | Focal |
|---|---|---|---|---|---|---|
| No. | Elements | curvature | or distance | index | number | length |
| S1 | First lens | 2.318 | 0.937 | 1.544 | 56.0 | 5.5159 |
| S2 | | 8.613 | 0.062 | | | |
| S3 | Second lens | 9.737 | 0.180 | 1.680 | 18.4 | −15.1275 |
| S4 | | 4.997 | 0.366 | | | |
| S5 | Third lens | 9.919 | 0.329 | 1.544 | 56.0 | 40.8565 |
| S6 | | 17.642 | 0.133 | | | |
| S7 | Fourth lens | −15.319 | 0.249 | 1.544 | 56.0 | 67.5987 |
| S8 | | −10.890 | 0.263 | | | |
| S9 | Fifth lens | 21.977 | 0.266 | 1.680 | 18.4 | −29.9194 |
| S10 | | 10.586 | 0.371 | | | |
| S11 | Sixth lens | 17.509 | 0.319 | 1.614 | 25.9 | −169.2503 |
| S12 | | 14.901 | 0.527 | | | |
| S13 | Seventh lens | 4.503 | 0.568 | 1.567 | 37.4 | 8.7774 |
| S14 | | 42.526 | 1.005 | | | |
| S15 | Eighth lens | 13.572 | 0.430 | 1.535 | 55.7 | −4.9538 |
| S16 | | 2.200 | 0.500 | | | |
| S17 | Filter | Infinity | 0.210 | 1.517 | 64.2 | |
| S18 | | Infinity | 0.374 | | | |
| S19 | Imaging plane | Infinity | | | | |

The total focal length f of the optical imaging system 300 may be 6.2878 mm, IMG HT may be 6.12 mm, and FOV may be 85.3°.

In the third example, the first lens 310 may have positive refractive power, the first surface of the first lens 310 may be convex, and the second surface of the first lens 310 may be concave.

The second lens 320 may have negative refractive power, the first surface of the second lens 320 may be convex, and the second surface of the second lens 320 may be concave.

The third lens 330 may have positive refractive power, the first surface of the third lens 330 may be convex, and a second surface of the third lens 330 may be concave.

The fourth lens 340 may have positive refractive power, the first surface of the fourth lens 340 may be concave, and the second surface of the fourth lens 340 may be convex.

The fifth lens 350 may have negative refractive power, the first surface of the fifth lens 350 may be convex, and the second surface of the fifth lens 350 may be concave.

The sixth lens 360 may have negative refractive power, the first surface of the sixth lens 360 may be convex in the paraxial region, and the second surface of the sixth lens 360 may be concave in the paraxial region.

Also, at least one inflection point may be formed on at least one of the first and second surfaces of the sixth lens 360. For example, the first surface of the sixth lens 360 may be convex in the paraxial region and may be concave in a portion other than the paraxial region. Also, the second surface of the sixth lens 360 may be concave in the paraxial region and may be convex in a portion other than the paraxial region.

The seventh lens 370 may have positive refractive power, the first surface of the seventh lens 370 may be convex in the paraxial region, and the second surface of the seventh lens 370 may be concave in the paraxial region.

Also, at least one inflection point may be formed on at least one of the first and second surfaces of the seventh lens 370. For example, the first surface of the seventh lens 370 may be convex in the paraxial region and may be concave in a portion other than the paraxial region. The second surface of the seventh lens 370 may be concave in the paraxial region and may be convex in a portion other than the paraxial region.

The eighth lens 380 may have negative refractive power, the first surface of the eighth lens 380 may be convex, and the second surface of the eighth lens 380 may be concave.

Also, at least one inflection point may be formed on at least one of the first and second surfaces of the eighth lens 380. For example, the first surface of the eighth lens 380 may be convex in the paraxial region and may be concave in a portion other than the paraxial region. The second surface of the eighth lens 380 may be concave in the paraxial region and may be convex in a portion other than the paraxial region.

Each surface of the first lens 310 to the eighth lens 380 may have an aspherical coefficient as in Table 6. For example, both the object-side surface and the image-side surface of the first lens 310 to the eighth lens 380 may be aspherical.

TABLE 6

| | S1 | S2 | S3 | S4 | S5 | S6 | S7 | S8 |
|---|---|---|---|---|---|---|---|---|
| Conic | −0.408 | 6.623 | 20.917 | 4.532 | −19.356 | 12.935 | 59.680 | −8.673 |
| constant (K) | | | | | | | | |
| 4th order | 9.025E−04 | −3.686E−03 | −1.161E−02 | −6.260E−03 | −2.124E−02 | −2.305E−02 | 7.707E−03 | 1.371E−02 |
| coefficient(A) | | | | | | | | |
| 6th order | 2.439E−02 | −5.932E−03 | 2.090E−02 | −1.340E−02 | −1.083E−02 | −2.827E−02 | 2.358E−04 | −3.150E−02 |
| coefficient(B) | | | | | | | | |
| 8th order | −7.803E−02 | 5.500E−02 | −6.022E−02 | 1.465E−01 | 1.122E−01 | 8.125E−02 | −1.906E−01 | 9.342E−02 |
| coefficient(C) | | | | | | | | |
| 10th order | 1.688E−01 | −1.791E−01 | 2.250E−01 | −5.897E−01 | −6.788E−01 | −3.492E−01 | 8.028E−01 | −3.788E−01 |
| coefficient(D) | | | | | | | | |
| 12th order | −2.500E−01 | 3.578E−01 | −6.034E−01 | 1.571E+00 | 2.405E+00 | 1.125E+00 | −2.003E+00 | 1.119E+00 |
| coefficient(E) | | | | | | | | |
| 14th order | 2.623E−01 | −4.836E−01 | 1.097E+00 | −2.971E+00 | −5.479E+00 | −2.445E+00 | 3.400E+00 | −2.233E+00 |
| coefficient(F) | | | | | | | | |
| 16th order | −1.982E−01 | 4.628E−01 | −1.375E+00 | 4.105E+00 | 8.523E+00 | 3.713E+00 | −4.065E+00 | 3.098E+00 |
| coefficient(G) | | | | | | | | |
| 18th order | 1.083E−01 | −3.202E−01 | 1.210E+00 | −4.181E+00 | −9.329E+00 | −4.028E+00 | 3.472E+00 | −3.045E+00 |
| coefficient(H) | | | | | | | | |
| 20th order | −4.251E−02 | 1.609E−01 | −7.552E−01 | 3.127E+00 | 7.266E+00 | 3.141E+00 | −2.125E+00 | 2.133E+00 |
| coefficient(J) | | | | | | | | |
| 22nd order | 1.172E−02 | −5.817E−02 | 3.324E−01 | −1.692E+00 | −4.007E+00 | −1.746E+00 | 9.226E−01 | −1.057E+00 |
| coefficient(L) | | | | | | | | |
| 24th order | −2.178E−03 | 1.476E−02 | −1.009E−01 | 6.432E−01 | 1.530E+00 | 6.744E−01 | −2.770E−01 | 3.616E−01 |
| coefficient(M) | | | | | | | | |
| 26th order | 2.511E−04 | −2.496E−03 | 2.012E−02 | −1.626E−01 | −3.849E−01 | −1.720E−01 | 5.455E−02 | −8.117E−02 |
| coefficient(N) | | | | | | | | |
| 28th order | −1.512E−05 | 2.535E−04 | −2.367E−03 | 2.454E−02 | 5.739E−02 | 2.603E−02 | −6.316E−03 | 1.075E−02 |
| coefficient(O) | | | | | | | | |
| 30th order | 2.842E−07 | −1.173E−05 | 1.246E−04 | −1.671E−03 | −3.843E−03 | −1.769E−03 | 3.243E−04 | −6.367E−04 |
| coefficient(P) | | | | | | | | |
| | S9 | S10 | S11 | S12 | S13 | S14 | S15 | S16 |
| Conic | −83.759 | −30.681 | 71.229 | −94.276 | −26.029 | 48.194 | 2.154 | −11.537 |
| constant (K) | | | | | | | | |
| 4th order | −2.932E−02 | −3.428E−02 | −8.391E−02 | −1.094E−01 | −6.270E−03 | −7.504E−03 | −1.721E−01 | −7.448E−02 |
| coefficient(A) | | | | | | | | |
| 6th order | −2.416E−02 | −6.408E−03 | 5.651E−02 | 9.688E−02 | −9.117E−03 | 6.769E−03 | 1.032E−01 | 3.905E−02 |
| coefficient(B) | | | | | | | | |
| 8th order | 1.308E−01 | 1.215E−01 | 2.435E−02 | −1.059E−01 | 3.275E−03 | −1.098E−02 | −5.211E−02 | −1.630E−02 |
| coefficient(C) | | | | | | | | |
| 10th order | −5.032E−01 | −5.123E−01 | −2.370E−01 | 8.924E−02 | −2.062E−03 | 6.677E−03 | 1.956E−02 | 4.944E−03 |
| coefficient(D) | | | | | | | | |
| 12th order | 1.136E+00 | 1.176E+00 | 5.114E−01 | −4.253E−02 | 1.242E−03 | −2.306E−03 | −5.129E−03 | −1.083E−03 |
| coefficient(E) | | | | | | | | |
| 14th order | −1.627E+00 | −1.751E+00 | −6.569E−01 | −2.012E−03 | −4.444E−04 | 4.683E−04 | 9.489E−04 | 1.738E−04 |
| coefficient(F) | | | | | | | | |
| 16th order | 1.525E+00 | 1.800E+00 | 5.657E−01 | 1.820E−02 | 5.913E−05 | −4.407E−05 | −1.263E−04 | −2.076E−05 |
| coefficient(G) | | | | | | | | |
| 18th order | −9.183E−01 | −1.313E+00 | −3.403E−01 | −1.353E−02 | 1.193E−05 | −3.513E−06 | 1.226E−05 | 1.855E−06 |
| coefficient(H) | | | | | | | | |
| 20th order | 3.143E−01 | 6.855E−01 | 1.451E−01 | 5.583E−03 | −6.163E−06 | 1.847E−06 | −8.697E−07 | −1.235E−07 |
| coefficient(J) | | | | | | | | |
| 22nd order | −2.254E−02 | −2.544E−01 | −4.368E−02 | −1.471E−03 | 1.125E−06 | −3.026E−07 | 4.466E−08 | 6.038E−09 |
| coefficient(L) | | | | | | | | |
| 24th order | −3.014E−02 | 6.550E−02 | 9.079E−03 | 2.528E−04 | −1.137E−07 | 2.876E−08 | −1.617E−09 | −2.102E−10 |
| coefficient(M) | | | | | | | | |
| 26th order | 1.397E−02 | −1.112E−02 | −1.240E−03 | −2.749E−05 | 6.694E−09 | −1.672E−09 | 3.920E−11 | 4.927E−12 |
| coefficient(N) | | | | | | | | |
| 28th order | −2.677E−03 | 1.120E−03 | 1.002E−04 | 1.721E−06 | −2.145E−10 | 5.533E−11 | −5.710E−13 | −6.956E−14 |
| coefficient(O) | | | | | | | | |
| 30th order | 2.021E−04 | −5.064E−05 | −3.633E−06 | −4.730E−08 | 2.879E−12 | −8.005E−13 | 3.780E−15 | 4.463E−16 |
| coefficient(P) | | | | | | | | |

Also, the optical imaging system 300 may have the aberration characteristics illustrated in FIG. 6.

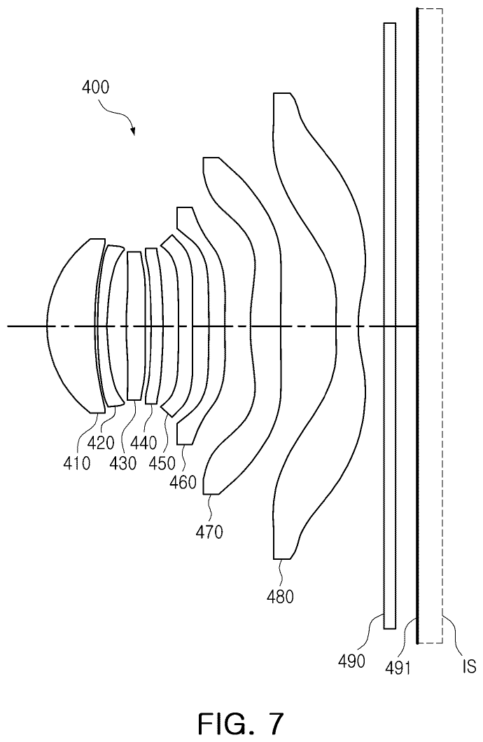

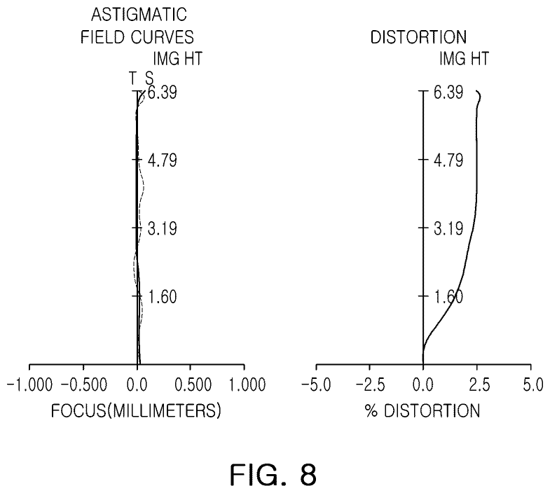

An optical imaging system 400 according to a fourth example will be described with reference to FIGS. 7 and 8.

The optical imaging system 400 may include an optical system including a first lens 410, a second lens 420, a third lens 430, a fourth lens 440, a fifth lens 450, a sixth lens 460, a seventh lens 470, and an eighth lens 480 and may further include a filter 490 and an image sensor IS.

The optical imaging system 400 may form a focus on the imaging plane 491. The imaging plane 491 may refer to a surface on which a focus may be formed by the optical imaging system. For example, the imaging plane 491 may refer to one surface of the image sensor IS on which light is received.

The lens characteristics of each lens (a radius of curvature, a thickness of the lens or a distance between the lenses, a refractive index, an Abbe number, and a focal length) are listed in Table 7.

TABLE 7

| Surface | | Radius of | Thickness | Refractive | Abbe | Focal |
|---|---|---|---|---|---|---|
| No. | Elements | curvature | or distance | index | number | length |
| S1 | First lens | 2.356 | 0.922 | 1.544 | 56.0 | 5.7024 |
| S2 | | 8.333 | 0.054 | | | |
| S3 | Second lens | 10.125 | 0.180 | 1.680 | 18.4 | −16.4577 |
| S4 | | 5.311 | 0.368 | | | |
| S5 | Third lens | 10.121 | 0.362 | 1.544 | 56.0 | 33.6493 |
| S6 | | 22.234 | 0.121 | | | |
| S7 | Fourth lens | −13.353 | 0.230 | 1.567 | 37.4 | 80.2515 |
| S8 | | −10.404 | 0.299 | | | |
| S9 | Fifth lens | 25.871 | 0.250 | 1.680 | 18.4 | −29.9879 |
| S10 | | 11.443 | 0.328 | | | |
| S11 | Sixth lens | 17.561 | 0.310 | 1.614 | 25.9 | −68.2357 |
| S12 | | 12.326 | 0.487 | | | |
| S13 | Seventh lens | 4.171 | 0.586 | 1.567 | 37.4 | 8.7035 |
| S14 | | 24.680 | 1.065 | | | |
| S15 | Eighth lens | 13.691 | 0.431 | 1.535 | 55.7 | −5.2190 |
| S16 | | 2.301 | 0.500 | | | |
| S17 | Filter | Infinity | 0.210 | 1.517 | 64.2 | |
| S18 | | Infinity | 0.388 | | | |
| S19 | Imaging plane | Infinity | | | | |

The total focal length f of the optical imaging system 400 may be 6.338 mm, IMG HT may be 6.12 mm, and FOV may be 85.3°.

In the fourth example, the first lens 410 may have positive refractive power, the first surface of the first lens 410 may be convex, and the second surface of the first lens 410 may be concave.

The second lens 420 may have negative refractive power, the first surface of the second lens 420 may be convex, and the second surface of the second lens 420 may be concave.

The third lens 430 may have positive refractive power, the first surface of the third lens 430 may be convex, and a second surface of the third lens 430 may be concave.

The fourth lens 440 may have positive refractive power, the first surface of the fourth lens 440 may be concave, and the second surface of the fourth lens 440 may be convex.

The fifth lens 450 may have negative refractive power, the first surface of the fifth lens 450 may be convex, and the second surface of the fifth lens 450 may be concave.

The sixth lens 460 may have negative refractive power, the first surface of the sixth lens 460 may be convex in the paraxial region, and the second surface of the sixth lens 460 may be concave in the paraxial region.

Also, at least one inflection point may be formed on at least one of the first and second surfaces of the sixth lens 460. For example, the first surface of the sixth lens 460 may be convex in the paraxial region and may be concave in a portion other than the paraxial region. The second surface of the sixth lens 460 may be concave in the paraxial region and may be convex in a portion other than the paraxial region.

The seventh lens 470 may have positive refractive power, the first surface of the seventh lens 470 may be convex in the paraxial region, and the second surface of the seventh lens 470 may be concave in the paraxial region.

Also, at least one inflection point may be formed on at least one of the first and second surfaces of the seventh lens 470. For example, the first surface of the seventh lens 470 may be convex in the paraxial region and may be concave in a portion other than the paraxial region. The second surface of the seventh lens 470 may be concave in the paraxial region and may be convex in a portion other than the paraxial region.

The eighth lens 480 may have negative refractive power, the first surface of the eighth lens 480 may be convex, and the second surface of the eighth lens 480 may be concave.

Also, at least one inflection point may be formed on at least one of the first and second surfaces of the eighth lens 480. For example, the first surface of the eighth lens 480 may be convex in the paraxial region and may be concave in a portion other than the paraxial region. The second surface of the eighth lens 480 may be concave in the paraxial region and may be convex in a portion other than the paraxial region.

Each surface of the first lens 410 to the eighth lens 480 may have an aspherical coefficient as in Table 8. For example, both the object-side surface and the image-side surface of the first lens 410 to the eighth lens 480 may be aspherical.

TABLE 8

| | S1 | S2 | S3 | S4 | S5 | S6 | S7 | S8 |
|---|---|---|---|---|---|---|---|---|
| Conic | −0.470 | 5.654 | 21.881 | 4.238 | −19.433 | −94.378 | 59.010 | −12.230 |
| constant (K) | | | | | | | | |
| 4th order | 7.265E−03 | −5.527E−03 | 1.308E−03 | 5.587E−03 | −9.396E−03 | −1.804E−02 | 1.001E−02 | −8.895E−03 |
| coefficient(A) | | | | | | | | |
| 6th order | −2.207E−02 | 8.955E−03 | −8.169E−02 | −1.150E−01 | −1.355E−01 | −7.668E−02 | −5.752E−02 | 1.322E−01 |
| coefficient(B) | | | | | | | | |
| 8th order | 1.018E−01 | −1.019E−01 | 3.599E−01 | 6.660E−01 | 8.053E−01 | 3.164E−01 | 3.071E−01 | −5.675E−01 |
| coefficient(C) | | | | | | | | |
| 10th order | −2.654E−01 | 4.658E−01 | −8.939E−01 | −2.290E+00 | −2.999E+00 | −9.997E−01 | −1.315E+00 | 1.429E+00 |
| coefficient(D) | | | | | | | | |
| 12th order | 4.525E−01 | −1.123E+00 | 1.546E+00 | 5.437E+00 | 7.506E+00 | 2.116E+00 | 3.636E+00 | −2.357E+00 |
| coefficient(E) | | | | | | | | |
| 14th order | −5.343E−01 | 1.709E+00 | −1.980E+00 | −9.318E+00 | −1.323E+01 | −2.937E+00 | −6.685E+00 | 2.664E+00 |
| coefficient(F) | | | | | | | | |
| 16th order | 4.516E−01 | −1.769E+00 | 1.921E+00 | 1.174E+01 | 1.686E+01 | 2.623E+00 | 8.493E+00 | −2.108E+00 |
| coefficient(G) | | | | | | | | |
| 18th order | −2.777E−01 | 1.290E+00 | −1.416E+00 | −1.091E+01 | −1.574E+01 | −1.385E+00 | −7.639E+00 | 1.180E+00 |
| coefficient(H) | | | | | | | | |
| 20th order | 1.246E−01 | −6.707E−01 | 7.856E−01 | 7.448E+00 | 1.078E+01 | 2.606E−01 | 4.909E+00 | −4.717E−01 |
| coefficient(J) | | | | | | | | |
| 22nd order | −4.036E−02 | 2.477E−01 | −3.208E−01 | −3.676E+00 | −5.341E+00 | 1.736E−01 | −2.243E+00 | 1.383E−01 |
| coefficient(L) | | | | | | | | |
| 24th order | 9.202E−03 | −6.347E−02 | 9.310E−02 | 1.274E+00 | 1.864E+00 | −1.499E−01 | 7.119E−01 | 3.181E−02 |
| coefficient(M) | | | | | | | | |
| 26th order | −1.400E−03 | 1.073E−02 | −1.812E−02 | −2.935E−01 | −4.339E−01 | 5.167E−02 | −1.493E−01 | 6.112E−03 |
| coefficient(N) | | | | | | | | |
| 28th order | 1.277E−04 | −1.076E−03 | 2.113E−03 | 4.036E−02 | 6.045E−02 | −8.994E−03 | 1.863E−02 | −8.854E−04 |
| coefficient(O) | | | | | | | | |
| 30th order | −5.276E−06 | 4.841E−05 | −1.116E−04 | −2.504E−03 | −3.809E−03 | 6.483E−04 | −1.048E−03 | 6.535E−05 |
| coefficient(P) | | | | | | | | |
| | S9 | S10 | S11 | S12 | S13 | S14 | S15 | S16 |
| Conic | −99.000 | −23.181 | 69.766 | −61.445 | −25.181 | 20.007 | 2.420 | −10.544 |
| constant (K) | | | | | | | | |
| 4th order | −4.248E−02 | −2.419E−02 | −8.235E−02 | −1.233E−01 | −7.603E−03 | −9.678E−03 | −1.429E−01 | −6.248E−02 |
| coefficient(A) | | | | | | | | |
| 6th order | 1.639E−01 | −1.211E−02 | 3.310E−02 | 1.448E−01 | −1.879E−02 | 2.845E−03 | 5.934E−02 | 2.165E−02 |
| coefficient(B) | | | | | | | | |
| 8th order | −9.586E−01 | 5.081E−02 | 2.487E−01 | −2.142E−01 | 2.419E−02 | −5.487E−03 | −2.068E−02 | −5.925E−03 |
| coefficient(C) | | | | | | | | |
| 10th order | 3.273E+00 | −1.792E−01 | −9.916E−01 | 2.689E−01 | −2.487E−02 | 4.617E−03 | 6.583E−03 | 1.287E−03 |
| coefficient(D) | | | | | | | | |
| 12th order | −7.546E+00 | 3.442E−01 | 1.956E+00 | −2.551E−01 | 1.716E−02 | −2.551E−03 | −1.683E−03 | −2.161E−04 |
| coefficient(E) | | | | | | | | |
| 14th order | 1.225E+01 | −4.107E−01 | −2.462E+00 | 1.747E−01 | −8.137E−03 | 9.565E−04 | 3.191E−04 | 2.688E−05 |
| coefficient(F) | | | | | | | | |
| 16th order | −1.428E+01 | 3.278E−01 | 2.121E+00 | −8.589E−02 | 2.672E−03 | −2.532E−04 | −4.394E−05 | −2.377E−06 |
| coefficient(G) | | | | | | | | |
| 18th order | 1.205E+01 | −1.817E−01 | −1.289E+00 | 3.027E−02 | −6.139E−04 | 4.853E−05 | 4.387E−06 | 1.410E−07 |
| coefficient(H) | | | | | | | | |
| 20th order | −7.368E+00 | 7.118E−02 | 5.575E−01 | −7.615E−03 | 9.953E−05 | −6.742E−06 | −3.172E−07 | −4.926E−09 |
| coefficient(J) | | | | | | | | |
| 22nd order | 3.227E+00 | −1.979E−02 | −1.707E−01 | 1.352E−03 | −1.138E−05 | 6.676E−07 | 1.645E−08 | 4.776E−11 |
| coefficient(L) | | | | | | | | |
| 24th order | −9.865E−01 | 3.878E−03 | 3.617E−02 | −1.651E−04 | 9.002E−07 | −4.559E−08 | −5.969E−10 | 3.822E−12 |
| coefficient(M) | | | | | | | | |
| 26th order | 1.998E−01 | −5.237E−04 | −5.038E−03 | 1.322E−05 | −4.702E−08 | 2.025E−09 | 1.439E−11 | −1.847E−13 |
| coefficient(N) | | | | | | | | |
| 28th order | −2.409E−02 | 4.537E−05 | 4.152E−04 | −6.255E−07 | 1.461E−09 | −5.225E−11 | −2.073E−13 | 3.481E−15 |
| coefficient(O) | | | | | | | | |
| 30th order | 1.308E−03 | −1.958E−06 | −1.533E−05 | 1.329E−08 | −2.047E−11 | 5.895E−13 | 1.351E−15 | −2.521E−17 |
| coefficient(P) | | | | | | | | |

Also, the optical imaging system 400 may have the aberration characteristics illustrated in FIG. 8.

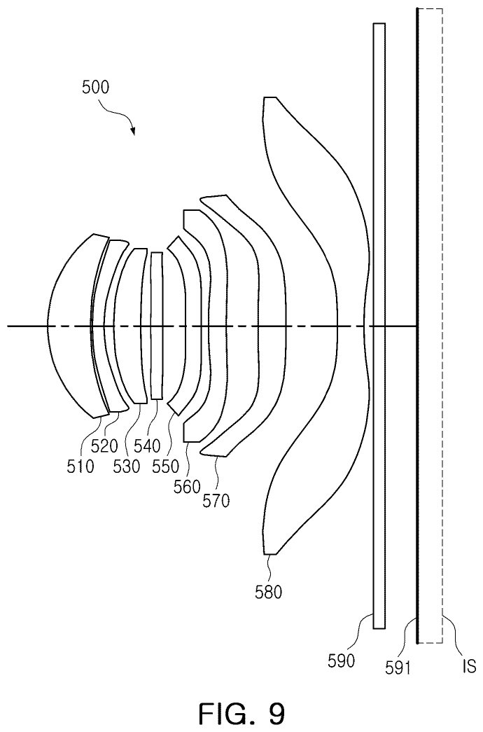

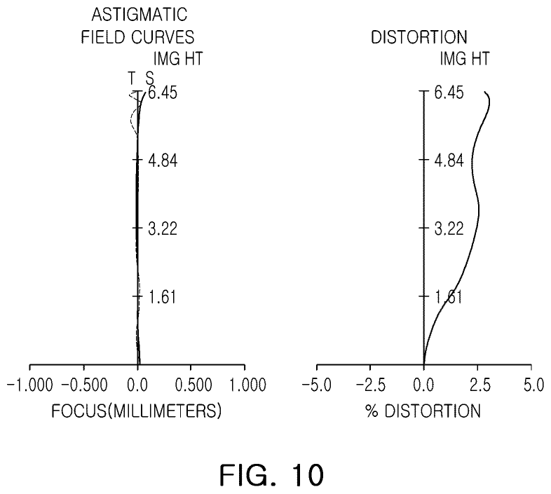

An optical imaging system 500 according to a fifth example will be described with reference to FIGS. 9 and 10.

The optical imaging system 500 may include an optical system including a first lens 510, a second lens 520, a third lens 530, a fourth lens 540, a fifth lens 550, a sixth lens 560, a seventh lens 570, and an eighth lens 580 and may further include a filter 590 and an image sensor IS.

The optical imaging system 500 may form a focus on the imaging plane 591. The imaging plane 591 may refer to a surface on which a focus may be formed by the optical imaging system. For example, the imaging plane 591 may refer to one surface of the image sensor IS on which light is received.

The lens characteristics of each lens (a radius of curvature, a thickness of the lens or a distance between the lenses, a refractive index, an Abbe number, and a focal length) are listed in Table 9.

TABLE 9

| Surface | | Radius of | Thickness | Refractive | Abbe | Focal |
|---|---|---|---|---|---|---|
| No. | Elements | curvature | or distance | index | number | length |
| S1 | First lens | 2.383 | 0.827 | 1.544 | 56.0 | 6.6309 |
| S2 | | 6.113 | 0.025 | | | |
| S3 | Second lens | 3.647 | 0.220 | 1.680 | 18.4 | −12.3881 |
| S4 | | 2.492 | 0.193 | | | |
| S5 | Third lens | 4.168 | 0.519 | 1.544 | 56.0 | 13.1311 |
| S6 | | 9.508 | 0.194 | | | |
| S7 | Fourth lens | 17.297 | 0.231 | 1.567 | 37.4 | 59.2288 |
| S8 | | 35.247 | 0.449 | | | |
| S9 | Fifth lens | −16.669 | 0.302 | 1.680 | 18.4 | −23.1961 |
| S10 | | 392.522 | 0.140 | | | |
| S11 | Sixth lens | 5.875 | 0.323 | 1.636 | 23.9 | 70.3968 |
| S12 | | 6.608 | 0.622 | | | |
| S13 | Seventh lens | 10.984 | 0.542 | 1.567 | 37.4 | 11.0237 |
| S14 | | −14.464 | 0.991 | | | |
| S15 | Eighth lens | −138.859 | 0.493 | 1.535 | 55.7 | −5.1737 |
| S16 | | 2.889 | 0.203 | | | |
| S17 | Filter | Infinity | 0.210 | 1.517 | 64.2 | |
| S18 | | Infinity | 0.603 | | | |
| S19 | Imaging plane | Infinity | | | | |

The total focal length f of the optical imaging system 500 may be 6.4215 mm, IMG HT may be 6.12 mm, and FOV may be 85.3°.

In the fifth example, the first lens 510 may have positive refractive power, the first surface of the first lens 510 may be convex, and the second surface of the first lens 510 may be concave.

The second lens 520 may have negative refractive power, the first surface of the second lens 520 may be convex, and the second surface of the second lens 520 may be concave.

The third lens 530 may have positive refractive power, the first surface of the third lens 530 may be convex, and a second surface of the third lens 530 may be concave.

The fourth lens 540 may have positive refractive power, the first surface of the fourth lens 540 may be convex, and the second surface of the fourth lens 540 may be concave.

The fifth lens 550 may have negative refractive power, and the first and second surfaces of the fifth lens 550 may be concave.

The sixth lens 560 may have negative refractive power, the first surface of the sixth lens 560 may be convex in the paraxial region, and the second surface of the sixth lens 560 may be concave in the paraxial region.

Also, at least one inflection point may be formed on at least one of the first and second surfaces of the sixth lens 560. For example, the first surface of the sixth lens 560 may be convex in the paraxial region and may be concave in a portion other than the paraxial region. The second surface of the sixth lens 560 may be concave in the paraxial region and may be convex in a portion other than the paraxial region.

The seventh lens 570 may have positive refractive power, and the first and second surfaces of the seventh lens 570 may be convex in the paraxial region.

Also, at least one inflection point may be formed on at least one of the first and second surfaces of the seventh lens 570. For example, the first surface of the seventh lens 570 may be convex in the paraxial region and may be concave in a portion other than the paraxial region. The second surface of the seventh lens 570 may be convex in the paraxial region and may be concave in a portion other than the paraxial region.

The eighth lens 580 may have negative refractive power, and the first and second surfaces of the eighth lens 580 may be concave in the paraxial region.

Also, at least one inflection point may be formed on at least one of the first and second surfaces of the eighth lens 580. For example, the first surface of the eighth lens 580 may be convex in the paraxial region and may be concave in a portion other than the paraxial region. The second surface of the eighth lens 580 may be concave in the paraxial region and may be convex in a portion other than the paraxial region.

Each surface of the first lens 510 to the eighth lens 580 may have an aspherical coefficient as in Table 10. For example, both the object-side surface and the image-side surface of the first lens 510 to the eighth lens 580 may be aspherical.

TABLE 10

| | S1 | S2 | S3 | S4 | S5 | S6 | S7 | S8 |
|---|---|---|---|---|---|---|---|---|
| Conic | −1.132 | 10.727 | −8.765 | −3.924 | 0.114 | 7.701 | −47.857 | −98.394 |
| constant (K) | | | | | | | | |
| 4th order | 1.241E−02 | 4.321E−02 | 3.189E−02 | 9.515E−03 | 6.391E−03 | −8.548E−03 | −1.946E−02 | −1.862E−02 |
| coefficient(A) | | | | | | | | |
| 6th order | −1.234E−02 | −1.274E−01 | −5.263E−02 | −6.809E−03 | −5.016E−03 | 3.294E−02 | −1.006E−02 | 3.258E−02 |
| coefficient(B) | | | | | | | | |
| 8th order | 4.870E−02 | 3.105E−01 | −1.792E−02 | −5.836E−03 | 4.441E−02 | −2.405E−01 | 6.389E−02 | −2.422E−01 |
| coefficient(C) | | | | | | | | |
| 10th order | −1.066E−01 | −6.288E−01 | 3.402E−01 | 6.921E−02 | −1.776E−01 | 1.064E+00 | −2.161E−01 | 1.035E+00 |
| coefficient(D) | | | | | | | | |
| 12th order | 1.508E−01 | 9.992E−01 | −9.568E−01 | −2.039E−01 | 4.921E−01 | −3.062E+00 | 4.556E−01 | −2.843E+00 |
| coefficient(E) | | | | | | | | |
| 14th order | −1.455E−01 | −1.224E+00 | 1.550E+00 | 3.451E−01 | −9.605E−01 | 6.074E+00 | −5.856E−01 | 5.359E+00 |
| coefficient(F) | | | | | | | | |
| 16th order | 9.871E−02 | 1.145E+00 | −1.669E+00 | −3.788E−01 | 1.339E+00 | −8.545E+00 | 4.076E−01 | −7.157E+00 |
| coefficient(G) | | | | | | | | |
| 18th order | −4.785E−02 | −8.099E−01 | 1.254E+00 | 2.807E−01 | −1.341E+00 | 8.653E+00 | −1.995E−02 | 6.887E+00 |
| coefficient(H) | | | | | | | | |
| 20th order | 1.660E−02 | 4.273E−01 | −6.679E−01 | −1.411E−01 | 9.648E−01 | −6.325E+00 | −2.547E−01 | −4.794E+00 |
| coefficient(J) | | | | | | | | |
| 22nd order | −4.071E−03 | −1.646E−01 | 2.515E−01 | 4.674E−02 | −4.934E−01 | 3.305E+00 | 2.657E−01 | 2.393E+00 |
| coefficient(L) | | | | | | | | |
| 24th order | 6.853E−04 | 4.476E−02 | −6.547E−02 | −9.353E−03 | 1.750E−01 | −1.204E+00 | −1.422E−01 | −8.356E−01 |
| coefficient(M) | | | | | | | | |
| 26th order | −7.459E−05 | −8.122E−03 | 1.121E−02 | 8.392E−04 | −4.089E−02 | 2.904E−01 | 4.458E−02 | 1.939E−01 |
| coefficient(N) | | | | | | | | |
| 28th order | 4.645E−06 | 8.809E−04 | −1.137E−03 | 3.333E−05 | 5.666E−03 | −4.164E−02 | −7.770E−03 | −2.686E−02 |
| coefficient(O) | | | | | | | | |
| 30th order | −1.214E−07 | −4.314E−05 | 5.165E−05 | −9.616E−06 | −3.527E−04 | 2.688E−03 | 5.839E−04 | 1.683E−03 |
| coefficient(P) | | | | | | | | |
| | S9 | S10 | S11 | S12 | S13 | S14 | S15 | S16 |
| Conic | 0.167 | −0.013 | −0.183 | −1.043 | 15.753 | 6.318 | 0.000 | −5.398 |
| constant (K) | | | | | | | | |
| 4th order | −1.237E−02 | −5.663E−02 | −9.480E−02 | −7.565E−02 | −1.988E−02 | −5.854E−03 | −1.150E−01 | −9.622E−02 |
| coefficient(A) | | | | | | | | |
| 6th order | −3.196E−02 | 1.552E−01 | 7.044E−02 | 5.341E−02 | −4.021E−02 | −1.319E−02 | 6.153E−02 | 5.515E−02 |
| coefficient(B) | | | | | | | | |
| 8th order | 8.887E−03 | −6.544E−01 | −2.638E−02 | −5.656E−02 | 1.003E−01 | 2.314E−02 | −3.004E−02 | −2.468E−02 |
| coefficient(C) | | | | | | | | |
| 10th order | 2.938E−01 | 1.883E+00 | −8.904E−02 | 6.576E−02 | −1.686E−01 | −3.690E−02 | 1.075E−02 | 7.982E−03 |
| coefficient(D) | | | | | | | | |
| 12th order | −1.415E+00 | −3.728E+00 | 2.351E−01 | −6.483E−02 | 1.813E−01 | 3.590E−02 | −2.625E−03 | −1.869E−03 |
| coefficient(E) | | | | | | | | |
| 14th order | 3.517E+00 | 5.158E+00 | −3.184E−01 | 4.737E−02 | −1.312E−01 | −2.287E−02 | 4.476E−04 | 3.217E−04 |
| coefficient(F) | | | | | | | | |
| 16th order | −5.574E+00 | −5.083E+00 | 2.810E−01 | −2.520E−02 | 6.594E−02 | 1.002E−02 | −5.472E−05 | −4.113E−05 |
| coefficient(G) | | | | | | | | |
| 18th order | 6.026E+00 | 3.611E+00 | −1.709E−01 | 9.799E−03 | −2.338E−02 | −3.095E−03 | 4.870E−06 | 3.915E−06 |
| coefficient(H) | | | | | | | | |
| 20th order | −4.558E+00 | −1.852E+00 | 7.279E−02 | −2.773E−03 | 5.861E−03 | 6.770E−04 | −3.166E−07 | −2.757E−07 |
| coefficient(J) | | | | | | | | |
| 22nd order | 2.416E+00 | 6.790E−01 | −2.163E−02 | 5.618E−04 | −1.028E−03 | −1.040E−04 | 1.488E−08 | 1.413E−08 |
| coefficient(L) | | | | | | | | |
| 24th order | −8.804E−01 | −1.733E−01 | 4.377E−03 | −7.890E−05 | 1.228E−04 | 1.096E−05 | −4.925E−10 | −5.115E−10 |
| coefficient(M) | | | | | | | | |
| 26th order | 2.103E−01 | 2.924E−02 | −5.733E−04 | 7.260E−06 | −9.463E−06 | −7.516E−07 | 1.088E−11 | 1.237E−11 |
| coefficient(N) | | | | | | | | |
| 28th order | −2.965E−02 | −2.926E−03 | 4.372E−05 | −3.917E−07 | 4.222E−07 | 3.022E−08 | −1.440E−13 | −1.790E−13 |
| coefficient(O) | | | | | | | | |
| 30th order | 1.871E−03 | 1.314E−04 | −1.473E−06 | 9.362E−09 | −8.221E−09 | −5.399E−10 | 8.622E−16 | 1.172E−15 |
| coefficient(P) | | | | | | | | |

Also, the optical imaging system 500 may have the aberration characteristics illustrated in FIG. 10.

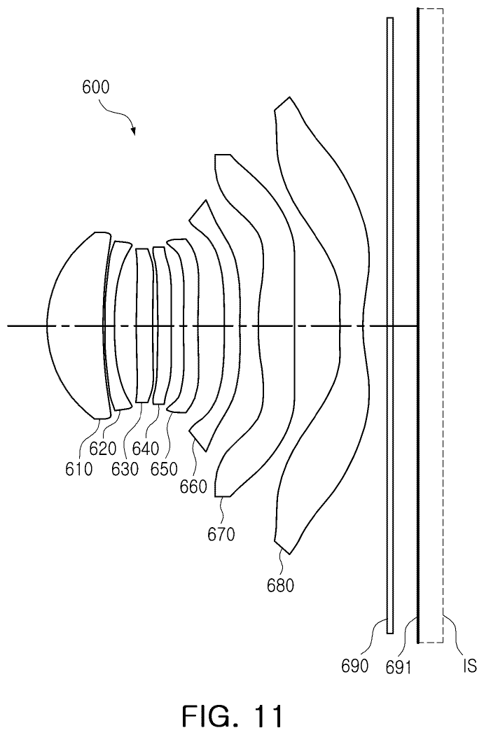

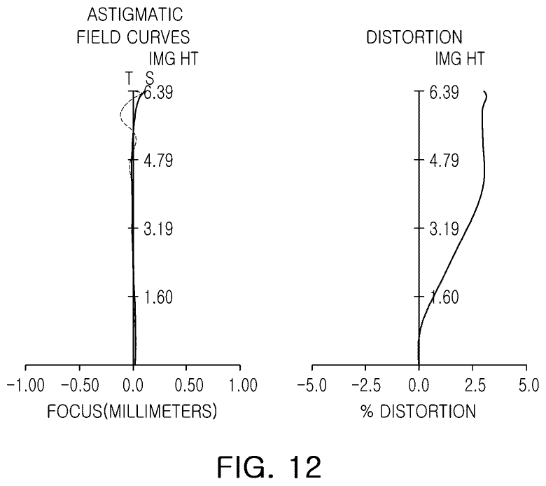

An optical imaging system 600 according to a sixth example will be described with reference to FIGS. 11 and 12.

The optical imaging system 600 may include an optical system including a first lens 610, a second lens 620, a third lens 630, a fourth lens 640, a fifth lens 650, a sixth lens 660, a seventh lens 670, and an eighth lens 680 and may further include a filter 690 and an image sensor IS.

The optical imaging system 600 may form a focus on the imaging plane 691. The imaging plane 691 may refer to a surface on which a focus may be formed by the optical imaging system. For example, the imaging plane 691 may refer to one surface of the image sensor IS on which light is received.

The lens characteristics of each lens (a radius of curvature, a thickness of the lens or a distance between the lenses, a refractive index, an Abbe number, and a focal length) are listed in Table 11.

TABLE 11

| Surface | | Radius of | Thickness | Refractive | Abbe | Focal |
|---|---|---|---|---|---|---|
| No. | Elements | curvature | or distance | index | number | length |
| S1 | First lens | 2.401 | 1.076 | 1.544 | 56.0 | 5.1969 |
| S2 | | 13.087 | 0.031 | | | |
| S3 | Second lens | 13.512 | 0.182 | 1.680 | 18.4 | −13.7430 |
| S4 | | 5.538 | 0.428 | | | |
| S5 | Third lens | 11.112 | 0.313 | 1.567 | 37.4 | −484.0360 |
| S6 | | 10.573 | 0.100 | | | |
| S7 | Fourth lens | −27.563 | 0.272 | 1.544 | 56.0 | 30.2715 |
| S8 | | −10.372 | 0.225 | | | |
| S9 | Fifth lens | 12.249 | 0.269 | 1.680 | 18.4 | −96.7222 |
| S10 | | 10.254 | 0.500 | | | |
| S11 | Sixth lens | 39.951 | 0.300 | 1.614 | 25.9 | −17.7825 |
| S12 | | 8.616 | 0.359 | | | |
| S13 | Seventh lens | 3.687 | 0.706 | 1.567 | 37.4 | 7.1288 |
| S14 | | 36.573 | 0.880 | | | |
| S15 | Eighth lens | 11.276 | 0.430 | 1.535 | 55.7 | −4.8715 |
| S16 | | 2.096 | 0.500 | | | |
| S17 | Filter | Infinity | 0.110 | 1.517 | 64.2 | |
| S18 | | Infinity | 0.409 | | | |
| S19 | Imaging plane | Infinity | | | | |

The total focal length f of the optical imaging system 600 may be 6.2999 mm, IMG HT may be 6.12 mm, and FOV may be 85.3°.

In the sixth example, the first lens 610 may have positive refractive power, the first surface of the first lens 610 may be convex, and the second surface of the first lens 610 may be concave.

The second lens 620 may have negative refractive power, the first surface of the second lens 620 may be convex, and the second surface of the second lens 620 may be concave.

The third lens 630 may have negative refractive power, the first surface of the third lens 630 may be convex, and a second surface of the third lens 630 may be concave.

The fourth lens 640 may have positive refractive power, the first surface of the fourth lens 640 may be concave, and the second surface of the fourth lens 640 may be convex.

The fifth lens 650 may have negative refractive power, the first surface of the fifth lens 650 may be convex, and the second surface of the fifth lens 650 may be concave.

The sixth lens 660 may have negative refractive power, the first surface of the sixth lens 660 may be convex in the paraxial region, and the second surface of the sixth lens 660 may be concave in the paraxial region.

Also, at least one inflection point may be formed on at least one of the first and second surfaces of the sixth lens 660. For example, the first surface of the sixth lens 660 may be convex in the paraxial region and may be concave in a portion other than the paraxial region. The second surface of the sixth lens 660 may be concave in the paraxial region and may be convex in a portion other than the paraxial region.

The seventh lens 670 may have positive refractive power, the first surface of the seventh lens 670 may be convex in the paraxial region, and the second surface of the seventh lens 670 may be concave in the paraxial region.

Also, at least one inflection point may be formed on at least one of the first and second surfaces of the seventh lens 670. For example, the first surface of the seventh lens 670 may be convex in the paraxial region and may be concave in a portion other than the paraxial region. The second surface of the seventh lens 670 may be concave in the paraxial region and may be convex in a portion other than the paraxial region.

The eighth lens 680 may have negative refractive power, the first surface of the eighth lens 680 may be convex in the paraxial region, and the second surface of the eighth lens 680 may be concave in the paraxial region.

Also, at least one inflection point may be formed on at least one of the first and second surfaces of the eighth lens 680. For example, the first surface of the eighth lens 680 may be convex in the paraxial region and may be concave in a portion other than the paraxial region. The second surface of the eighth lens 680 may be concave in the paraxial region and may be convex in a portion other than the paraxial region.

Each surface of the first lens 610 to the eighth lens 680 may have an aspherical coefficient as in Table 12. For example, both the object-side surface and the image-side surface of the first lens 610 to the eighth lens 680 may be aspherical.

TABLE 12

| | S1 | S2 | S3 | S4 | S5 | S6 | S7 | S8 |
|---|---|---|---|---|---|---|---|---|
| Conic | −0.472 | 19.878 | 43.062 | 4.404 | −42.244 | −26.573 | 33.440 | 4.835 |
| constant (K) | | | | | | | | |
| 4th order | −4.069E−05 | 7.114E−03 | 6.213E−03 | 2.233E−03 | −1.704E−02 | −1.643E−02 | 1.226E−02 | −9.016E−03 |
| coefficient(A) | | | | | | | | |
| 6th order | 2.666E−02 | −1.177E−02 | 8.323E−03 | 5.563E−03 | −1.273E−02 | −8.563E−04 | −7.623E−02 | 3.146E−02 |
| coefficient(B) | | | | | | | | |
| 8th order | −9.623E−02 | 5.855E−02 | −4.801E−02 | −2.051E−02 | 1.965E−02 | −1.017E−01 | 3.997E−01 | −1.699E−01 |
| coefficient(C) | | | | | | | | |
| 10th order | 2.321E−01 | −2.574E−01 | 6.727E−02 | −1.153E−02 | −7.469E−03 | 3.904E−01 | −1.587E+00 | 5.889E−01 |
| coefficient(D) | | | | | | | | |
| 12th order | −3.773E−01 | 6.589E−01 | 3.798E−02 | 2.582E−01 | −7.120E−02 | −8.779E−01 | 4.212E+00 | −1.331E+00 |
| coefficient(E) | | | | | | | | |
| 14th order | 4.271E−01 | −1.062E+00 | −2.683E−01 | −7.954E−01 | 2.312E−01 | 1.263E+00 | −7.703E+00 | 2.093E+00 |
| coefficient(F) | | | | | | | | |
| 16th order | −3.442E−01 | 1.150E+00 | 4.506E−01 | 1.345E+00 | −3.823E−01 | −1.188E+00 | 9.933E+00 | −2.365E+00 |
| coefficient(G) | | | | | | | | |
| 18th order | 1.999E−01 | −8.672E−01 | −4.376E−01 | −1.470E+00 | 4.025E−01 | 7.002E−01 | −9.168E+00 | 1.950E+00 |
| coefficient(H) | | | | | | | | |
| 20th order | −8.382E−02 | 4.622E−01 | 2.796E−01 | 1.095E+00 | −2.856E−01 | −2.070E−01 | 6.083E+00 | −1.176E+00 |
| coefficient(J) | | | | | | | | |
| 22nd order | 2.512E−02 | −1.737E−01 | −1.217E−01 | −5.633E−01 | 1.382E−01 | −2.212E−02 | −2.878E+00 | 5.143E−01 |
| coefficient(L) | | | | | | | | |
| 24th order | −5.244E−03 | 4.511E−02 | 3.589E−02 | 1.974E−01 | −4.485E−02 | 4.608E−02 | 9.472E−01 | −1.589E−01 |
| coefficient(M) | | | | | | | | |
| 26th order | 7.243E−04 | −7.704E−03 | −6.881E−03 | −4.506E−02 | 9.297E−03 | −1.825E−02 | −2.059E−01 | 3.292E−02 |
| coefficient(N) | | | | | | | | |
| 28th order | −5.946E−05 | 7.792E−04 | 7.752E−04 | 6.047E−03 | −1.104E−03 | 3.385E−03 | 2.659E−02 | −4.109E−03 |
| coefficient(O) | | | | | | | | |
| 30th order | 2.196E−06 | −3.537E−05 | −3.898E−05 | −3.623E−04 | 5.630E−05 | −2.538E−04 | −1.543E−03 | 2.338E−04 |
| coefficient(P) | | | | | | | | |
| | S9 | S10 | S11 | S12 | S13 | S14 | S15 | S16 |
| Conic | 47.472 | −6.364 | 79.104 | −57.488 | −17.787 | −24.513 | 0.343 | −11.562 |
| constant (K) | | | | | | | | |
| 4th order | −3.935E−02 | −4.143E−02 | −8.265E−02 | −1.261E−01 | −1.956E−02 | −9.205E−03 | −2.056E−01 | −9.573E−02 |
| coefficient(A) | | | | | | | | |
| 6th order | −1.967E−02 | 8.241E−02 | 7.890E−02 | 1.196E−01 | 1.191E−02 | 1.627E−02 | 1.284E−01 | 5.279E−02 |
| coefficient(B) | | | | | | | | |
| 8th order | 7.208E−03 | −3.658E−01 | −7.502E−02 | −1.338E−01 | −2.059E−02 | −1.725E−02 | −5.706E−02 | −2.070E−02 |
| coefficient(C) | | | | | | | | |
| 10th order | 1.905E−01 | 1.000E+00 | 5.715E−02 | 1.368E−01 | 1.877E−02 | 9.522E−03 | 1.773E−02 | 5.772E−03 |
| coefficient(D) | | | | | | | | |
| 12th order | −8.385E−01 | −1.833E+00 | −3.284E−02 | −1.124E−01 | −1.246E−02 | −3.799E−03 | −3.873E−03 | −1.179E−03 |
| coefficient(E) | | | | | | | | |
| 14th order | 1.882E+00 | 2.336E+00 | 1.243E−02 | 6.995E−02 | 6.029E−03 | 1.194E−03 | 6.105E−04 | 1.803E−04 |
| coefficient(F) | | | | | | | | |
| 16th order | −2.672E+00 | −2.117E+00 | −2.834E−03 | −3.229E−02 | −2.092E−03 | −2.956E−04 | −7.088E−05 | −2.086E−05 |
| coefficient(G) | | | | | | | | |
| 18th order | 2.572E+00 | 1.379E+00 | 7.794E−04 | 1.093E−02 | 5.147E−04 | 5.603E−05 | 6.123E−06 | 1.826E−06 |
| coefficient(H) | | | | | | | | |
| 20th order | −1.725E+00 | −6.477E−01 | −6.568E−04 | −2.686E−03 | −8.899E−05 | −7.877E−06 | −3.931E−07 | −1.201E−07 |
| coefficient(J) | | | | | | | | |
| 22nd order | 8.079E−01 | 2.169E−01 | 4.016E−04 | 4.712E−04 | 1.069E−05 | 7.973E−07 | 1.852E−08 | 5.835E−09 |
| coefficient(L) | | | | | | | | |
| 24th order | −2.595E−01 | −5.048E−02 | −1.362E−04 | −5.735E−05 | −8.724E−07 | −5.613E−08 | −6.227E−10 | −2.030E−10 |
| coefficient(M) | | | | | | | | |
| 26th order | 5.454E−02 | 7.750E−03 | 2.621E−05 | 4.594E−06 | 4.610E−08 | 2.600E−09 | 1.414E−11 | 4.778E−12 |
| coefficient(N) | | | | | | | | |
| 28th order | −6.754E−03 | −7.050E−04 | −2.703E−06 | −2.177E−07 | −1.424E−09 | −7.116E−11 | −1.947E−13 | −6.809E−14 |
| coefficient(O) | | | | | | | | |
| 30th order | 3.739E−04 | 2.875E−05 | 1.164E−07 | 4.622E−09 | 1.952E−11 | 8.706E−13 | 1.227E−15 | 4.430E−16 |
| coefficient(P) | | | | | | | | |

Also, the optical imaging system 600 may have the aberration characteristics illustrated in FIG. 12.

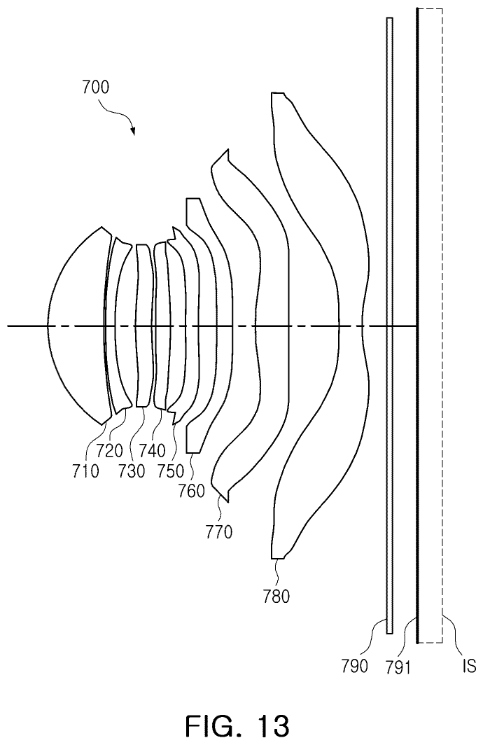

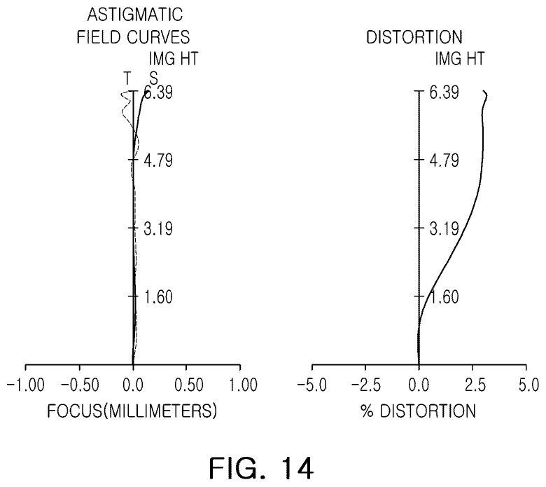

An optical imaging system 700 according to a seventh example will be described with reference to FIGS. 13 and 14.

The optical imaging system 700 may include an optical system including a first lens 710, a second lens 720, a third lens 730, a fourth lens 740, a fifth lens 750, a sixth lens 760, a seventh lens 770, and an eighth lens 780 and may further include a filter 790 and an image sensor IS.

The optical imaging system 700 may form a focus on the imaging plane 791. The imaging plane 791 may refer to a surface on which a focus may be formed by the optical imaging system. For example, the imaging plane 791 may refer to one surface of the image sensor IS on which light is received.

The lens characteristics of each lens (a radius of curvature, a thickness of the lens or a distance between the lenses, a refractive index, an Abbe number, and a focal length) are listed in Table 13.

TABLE 13

| Surface | | Radius of | Thickness | Refractive | Abbe | Focal |
|---|---|---|---|---|---|---|
| No. | Elements | curvature | or distance | index | number | length |
| S1 | First lens | 2.397 | 1.111 | 1.544 | 56.0 | 5.0950 |
| S2 | | 14.447 | 0.031 | | | |
| S3 | Second lens | 17.241 | 0.182 | 1.661 | 20.4 | −11.6221 |
| S4 | | 5.332 | 0.384 | | | |
| S5 | Third lens | 7.898 | 0.311 | 1.544 | 56.0 | −978.5210 |
| S6 | | 7.674 | 0.084 | | | |
| S7 | Fourth lens | 1186.956 | 0.268 | 1.544 | 56.0 | 24.9908 |
| S8 | | −13.811 | 0.296 | | | |
| S9 | Fifth lens | 14.023 | 0.256 | 1.661 | 20.4 | −39.0391 |
| S10 | | 9.054 | 0.349 | | | |
| S11 | Sixth lens | 18.885 | 0.300 | 1.614 | 25.9 | −36.9758 |
| S12 | | 10.292 | 0.434 | | | |
| S13 | Seventh lens | 4.103 | 0.644 | 1.567 | 37.4 | 7.8105 |
| S14 | | 48.603 | 0.965 | | | |
| S15 | Eighth lens | 11.452 | 0.450 | 1.535 | 55.7 | −4.8177 |
| S16 | | 2.082 | 0.500 | | | |
| S17 | Filter | Infinity | 0.110 | 1.517 | 64.2 | |
| S18 | | Infinity | 0.414 | | | |
| S19 | Imaging plane | Infinity | | | | |

The total focal length f of the optical imaging system 700 may be 6.2796 mm, IMG HT may be 6.12 mm, and FOV may be 85.3°.

In the seventh example, the first lens 710 may have positive refractive power, the first surface of the first lens 710 may be convex, and the second surface of the first lens 710 may be concave.

The second lens 720 may have negative refractive power, the first surface of the second lens 720 may be convex, and the second surface of the second lens 720 may be concave.

The third lens 730 may have negative refractive power, the first surface of the third lens 730 may be convex, and the second surface of the third lens 730 may be concave.

The fourth lens 740 may have positive refractive power, and the first and second surfaces of the fourth lens 740 may be convex.

The fifth lens 750 may have negative refractive power, the first surface of the fifth lens 750 may be convex, and the second surface of the fifth lens 750 may be concave.

The sixth lens 760 may have negative refractive power, the first surface of the sixth lens 760 may be convex in the paraxial region, and the second surface of the sixth lens 760 may be concave in the paraxial region.

Also, at least one inflection point may be formed on at least one of the first and second surfaces of the sixth lens 760. For example, the first surface of the sixth lens 760 may be convex in the paraxial region and may be concave in a portion other than the paraxial region. The second surface of the sixth lens 760 may be concave in the paraxial region and may be convex in a portion other than the paraxial region.

The seventh lens 770 may have positive refractive power, the first surface of the seventh lens 770 may be convex in the paraxial region, and the second surface of the seventh lens 770 may be concave in the paraxial region.

Also, at least one inflection point may be formed on at least one of the first and second surfaces of the seventh lens 770. For example, the first surface of the seventh lens 770 may be convex in the paraxial region and may be concave in a portion other than the paraxial region. The second surface of the seventh lens 770 may be concave in the paraxial region and may be convex in a portion other than the paraxial region.

The eighth lens 780 may have negative refractive power, the first surface of the eighth lens 780 may be convex in the paraxial region, and the second surface of the eighth lens 780 may be concave in the paraxial region.

Also, at least one inflection point may be formed on at least one of the first and second surfaces of the eighth lens 780. For example, the first surface of the eighth lens 780 may be convex in the paraxial region and may be concave in a portion other than the paraxial region. The second surface of the eighth lens 780 may be concave in the paraxial region and may be convex in a portion other than the paraxial region.

Each surface of the first lens 710 to the eighth lens 780 may have an aspherical coefficient as in Table 14. For example, both the object-side surface and the image-side surface of the first lens 710 to the eighth lens 780 may be aspherical.

TABLE 14

| | S1 | S2 | S3 | S4 | S5 | S6 | S7 | S8 |
|---|---|---|---|---|---|---|---|---|
| Conic | −0.469 | 20.363 | 44.822 | 3.231 | −46.223 | −27.253 | −99.000 | −35.057 |
| constant (K) | | | | | | | | |
| 4th order | −5.444E−03 | −1.298E−02 | −1.243E−02 | −1.153E−02 | −9.223E−03 | −1.970E−02 | −1.069E−03 | 2.330E−03 |
| coefficient(A) | | | | | | | | |
| 6th order | 5.387E−02 | 7.982E−02 | 6.592E−02 | 6.294E−02 | −7.995E−02 | 3.662E−02 | 7.533E−02 | −6.516E−02 |
| coefficient(B) | | | | | | | | |
| 8th order | −1.791E−01 | −2.413E−01 | −1.730E−01 | −2.525E−01 | 4.157E−01 | −3.054E−01 | −3.978E−01 | 3.911E−01 |
| coefficient(C) | | | | | | | | |
| 10th order | 3.964E−01 | 5.003E−01 | 3.399E−01 | 7.231E−01 | −1.623E+00 | 1.127E+00 | 1.214E+00 | −1.339E+00 |
| coefficient(D) | | | | | | | | |
| 12th order | −6.014E−01 | −7.232E−01 | −4.910E−01 | −1.409E+00 | 4.372E+00 | −2.782E+00 | −2.518E+00 | 3.078E+00 |
| coefficient(E) | | | | | | | | |
| 14th order | 6.452E−01 | 7.273E−01 | 5.075E−01 | 1.883E+00 | −8.215E+00 | 4.777E+00 | 3.667E+00 | −4.970E+00 |
| coefficient(F) | | | | | | | | |
| 16th order | −4.990E−01 | −5.078E−01 | −3.704E−01 | −1.725E+00 | 1.097E+01 | −5.858E+00 | −3.875E+00 | 5.758E+00 |
| coefficient(G) | | | | | | | | |
| 18th order | 2.809E−01 | 2.425E−01 | 1.881E−01 | 1.061E+00 | −1.052E+01 | 5.200E+00 | 3.030E+00 | −4.835E+00 |
| coefficient(H) | | | | | | | | |
| 20th order | −1.150E−01 | −7.515E−02 | −6.393E−02 | −4.027E−01 | 7.267E+00 | −3.340E+00 | −1.759E+00 | 2.943E+00 |
| coefficient(J) | | | | | | | | |
| 22nd order | 3.386E−02 | 1.263E−02 | 1.293E−02 | 6.469E−02 | −3.582E+00 | 1.534E+00 | 7.502E−01 | −1.284E+00 |
| coefficient(L) | | | | | | | | |
| 24th order | −6.976E−03 | −4.789E−06 | −8.322E−04 | 1.642E−02 | 1.228E+00 | −4.902E−01 | −2.285E−01 | 3.910E−01 |
| coefficient(M) | | | | | | | | |
| 26th order | 9.537E−04 | −4.695E−04 | −2.617E−04 | −1.124E−02 | −2.782E−01 | 1.034E−01 | 4.711E−02 | −7.882E−02 |
| coefficient(N) | | | | | | | | |
| 28th order | −7.770E−05 | 8.892E−05 | 6.690E−05 | 2.399E−03 | 3.745E−02 | −1.295E−02 | −5.890E−03 | 9.446E−03 |
| coefficient(O) | | | | | | | | |
| 30th order | 2.853E−06 | −5.722E−06 | −4.932E−06 | −1.932E−04 | −2.268E−03 | 7.275E−04 | 3.370E−04 | −5.091E−04 |
| coefficient(P) | | | | | | | | |
| | S9 | S10 | S11 | S12 | S13 | S14 | S15 | S16 |
| Conic | 55.329 | −23.225 | 22.802 | −23.725 | −17.498 | 42.252 | 0.011 | −11.208 |
| constant (K) | | | | | | | | |
| 4th order | −4.619E−02 | −5.235E−02 | −1.004E−01 | −1.311E−01 | −1.862E−02 | −8.799E−03 | −1.967E−01 | −8.966E−02 |
| coefficient(A) | | | | | | | | |
| 6th order | 2.036E−02 | 1.224E−01 | 1.064E−01 | 1.172E−01 | 1.033E−02 | 1.713E−02 | 1.172E−01 | 4.435E−02 |
| coefficient(B) | | | | | | | | |
| 8th order | −1.386E−01 | −4.570E−01 | −9.310E−02 | −1.277E−01 | −1.877E−02 | −2.064E−02 | −5.074E−02 | −1.520E−02 |
| coefficient(C) | | | | | | | | |
| 10th order | 5.482E−01 | 1.143E+00 | 1.663E−02 | 1.343E−01 | 1.715E−02 | 1.339E−02 | 1.580E−02 | 3.584E−03 |
| coefficient(D) | | | | | | | | |
| 12th order | −1.423E+00 | −1.968E+00 | 1.023E−01 | −1.181E−01 | −1.160E−02 | −6.364E−03 | −3.541E−03 | −5.903E−04 |
| coefficient(E) | | | | | | | | |
| 14th order | 2.510E+00 | 2.381E+00 | −1.822E−01 | 8.068E−02 | 5.770E−03 | 2.317E−03 | 5.818E−04 | 6.849E−05 |
| coefficient(F) | | | | | | | | |
| 16th order | −3.096E+00 | −2.061E+00 | 1.715E−01 | −4.129E−02 | −2.055E−03 | −6.359E−04 | −7.121E−05 | −5.576E−06 |
| coefficient(G) | | | | | | | | |
| 18th order | 2.717E+00 | 1.288E+00 | −1.053E−01 | 1.551E−02 | 5.165E−04 | 1.289E−04 | 6.529E−06 | 3.113E−07 |
| coefficient(H) | | | | | | | | |
| 20th order | −1.705E+00 | −5.824E−01 | 4.440E−02 | −4.208E−03 | −9.081E−05 | −1.895E−05 | −4.467E−07 | −1.125E−08 |
| coefficient(J) | | | | | | | | |
| 22nd order | 7.589E−01 | 1.884E−01 | −1.299E−02 | 8.112E−04 | 1.106E−05 | 1.986E−06 | 2.246E−08 | 2.268E−10 |
| coefficient(L) | | | | | | | | |
| 24th order | −2.340E−01 | −4.245E−02 | 2.595E−03 | −1.081E−04 | −9.121E−07 | −1.441E−07 | −8.054E−10 | −1.142E−12 |
| coefficient(M) | | | | | | | | |
| 26th order | 4.747E−02 | 6.324E−03 | −3.375E−04 | 9.446E−06 | 4.866E−08 | 6.873E−09 | 1.949E−11 | −3.853E−14 |
| coefficient(N) | | | | | | | | |
| 28th order | −5.697E−03 | −5.591E−04 | 2.581E−05 | −4.874E−07 | −1.516E−09 | −1.937E−10 | −2.850E−13 | 3.670E−16 |
| coefficient(O) | | | | | | | | |
| 30th order | 3.063E−04 | 2.218E−05 | −8.817E−07 | 1.125E−08 | 2.095E−11 | 2.442E−12 | 1.902E−15 | 4.411E−18 |
| coefficient(P) | | | | | | | | |

Also, the optical imaging system 700 may have the aberration characteristics illustrated in FIG. 14.

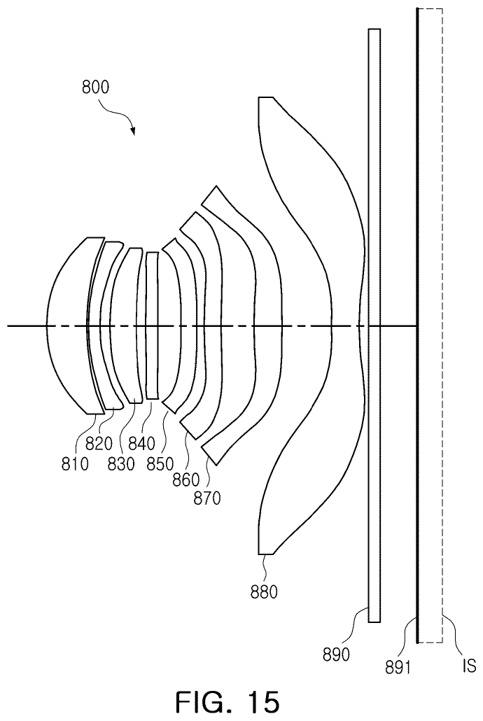

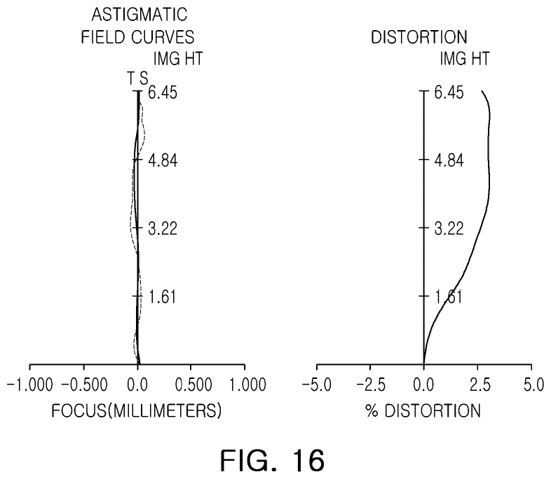

An optical imaging system 800 according to an eighth example will be described with reference to FIGS. 15 and 16.

The optical imaging system 800 may include an optical system including a first lens 810, a second lens 820, a third lens 830, a fourth lens 840, a fifth lens 850, a sixth lens 860, a seventh lens 870, and an eighth lens 880 and may further include a filter 890 and an image sensor IS.

The optical imaging system 800 may form a focus on the imaging plane 891. The imaging plane 891 may refer to a surface on which a focus may be formed by the optical imaging system. For example, the imaging plane 891 may refer to one surface of the image sensor IS on which light is received.

The lens characteristics of each lens (a radius of curvature, a thickness of the lens or a distance between the lenses, a refractive index, an Abbe number, and a focal length) are listed in Table 15.

TABLE 15

| Surface | | Radius of | Thickness | Refractive | Abbe | Focal |
|---|---|---|---|---|---|---|
| No. | Elements | curvature | or distance | index | number | length |
| S1 | First lens | 2.382 | 0.771 | 1.544 | 56.0 | 6.6739 |
| S2 | | 6.085 | 0.032 | | | |
| S3 | Second lens | 3.941 | 0.220 | 1.680 | 18.4 | −12.8709 |
| S4 | | 2.667 | 0.190 | | | |
| S5 | Third lens | 4.159 | 0.514 | 1.567 | 37.4 | 14.0375 |
| S6 | | 8.691 | 0.181 | | | |
| S7 | Fourth lens | 16.507 | 0.235 | 1.544 | 56.0 | 45.9302 |
| S8 | | 44.345 | 0.449 | | | |
| S9 | Fifth lens | −13.714 | 0.298 | 1.680 | 18.4 | −22.0901 |
| S10 | | −139.523 | 0.139 | | | |
| S11 | Sixth lens | 5.699 | 0.323 | 1.614 | 25.9 | 68.9711 |
| S12 | | 6.397 | 0.641 | | | |
| S13 | Seventh lens | 10.826 | 0.537 | 1.567 | 37.4 | 10.6626 |
| S14 | | −13.648 | 0.954 | | | |
| S15 | Eighth lens | −482.280 | 0.520 | 1.535 | 55.7 | −5.1940 |
| S16 | | 2.856 | 0.209 | | | |
| S17 | Filter | Infinity | 0.210 | 1.517 | 64.2 | |
| S18 | | Infinity | 0.706 | | | |
| S19 | Imaging plane | Infinity | | | | |

The total focal length f of the optical imaging system 800 may be 6.4236 mm, IMG HT may be 6.12 mm, and FOV may be 85.3°.

In the eighth example, the first lens 810 may have positive refractive power, the first surface of the first lens 810 may be convex, and the second surface of the first lens 810 may be concave.

The second lens 820 may have negative refractive power, the first surface of the second lens 820 may be convex, and the second surface of the second lens 820 may be concave.

The third lens 830 may have positive refractive power, the first surface of the third lens 830 may be convex, and the second surface of the third lens 830 may be concave.

The fourth lens 840 may have positive refractive power, the first surface of the fourth lens 840 may be convex, and the second surface of the fourth lens 840 may be concave.

The fifth lens 850 may have negative refractive power, the first surface of the fifth lens 850 may be concave, and the second surface of the fifth lens 850 may be convex.

The sixth lens 860 may have positive refractive power, the first surface of the sixth lens 860 may be convex in the paraxial region, and the second surface of the sixth lens 860 may be concave in the paraxial region.

Also, at least one inflection point may be formed on at least one of the first and second surfaces of the sixth lens 860. For example, the first surface of the sixth lens 860 may be convex in the paraxial region and may be concave in a portion other than the paraxial region. The second surface of the sixth lens 860 may be concave in the paraxial region and may be convex in a portion other than the paraxial region.

The seventh lens 870 may have positive refractive power, and the first and second surfaces of the seventh lens 870 may be convex in the paraxial region.

Also, at least one inflection point may be formed on at least one of the first and second surfaces of the seventh lens 870. For example, the first surface of the seventh lens 870 may be convex in the paraxial region and may be concave in a portion other than the paraxial region. The second surface of the seventh lens 870 may be convex in the paraxial region and may be concave in a portion other than the paraxial region.

The eighth lens 880 may have negative refractive power, and the first and second surfaces of the eighth lens 880 may be concave in the paraxial region.

Also, at least one inflection point may be formed on at least one of the first and second surfaces of the eighth lens 880. For example, the first surface of the eighth lens 880 may be concave in the paraxial region and may be convex in a portion other than the paraxial region. The second surface of the eighth lens 880 may be concave in the paraxial region and may be convex in a portion other than the paraxial region.

Each surface of the first lens 810 to the eighth lens 880 may have an aspherical coefficient as in Table 16. For example, both the object-side surface and the image-side surface of the first lens 810 to the eighth lens 880 may be aspherical.

TABLE 16

| | S1 | S2 | S3 | S4 | S5 | S6 | S7 | S8 |
|---|---|---|---|---|---|---|---|---|
| Conic | −1.162 | 10.791 | −8.212 | −3.857 | 0.010 | −0.002 | 0.520 | −0.827 |
| constant (K) | | | | | | | | |
| 4th order | 1.648E−02 | 4.441E−02 | 3.529E−02 | 1.238E−02 | 2.342E−03 | −2.183E−02 | −2.266E−02 | −1.372E−02 |
| coefficient(A) | | | | | | | | |
| 6th order | −4.534E−02 | −1.542E−01 | −7.531E−02 | −2.290E−03 | 2.698E−02 | 1.499E−01 | 1.871E−03 | −1.506E−02 |
| coefficient(B) | | | | | | | | |
| 8th order | 1.833E−01 | 4.462E−01 | 6.882E−02 | −7.149E−02 | −4.584E−02 | −8.391E−01 | −3.298E−03 | 1.873E−02 |
| coefficient(C) | | | | | | | | |
| 10th order | −4.392E−01 | −1.032E+00 | 1.147E−01 | 3.224E−01 | −1.776E−01 | 2.891E+00 | −3.326E−02 | 1.844E−01 |
| coefficient(D) | | | | | | | | |
| 12th order | 6.921E−01 | 1.802E+00 | −5.227E−01 | −7.677E−01 | 1.136E+00 | −6.618E+00 | 2.646E−01 | −1.054E+00 |
| coefficient(E) | | | | | | | | |
| 14th order | −7.537E−01 | −2.329E+00 | 9.287E−01 | 1.160E+00 | −2.893E+00 | 1.055E+01 | −8.331E−01 | 2.887E+00 |
| coefficient(F) | | | | | | | | |
| 16th order | 5.846E−01 | 2.223E+00 | −1.014E+00 | −1.181E+00 | 4.446E+00 | −1.202E+01 | 1.568E+00 | −4.976E+00 |
| coefficient(G) | | | | | | | | |
| 18th order | −3.281E−01 | −1.566E+00 | 7.463E−01 | 8.270E−01 | −4.561E+00 | 9.918E+00 | −1.948E+00 | 5.843E+00 |
| coefficient(H) | | | | | | | | |
| 20th order | 1.337E−01 | 8.093E−01 | −3.820E−01 | −3.963E−01 | 3.240E+00 | −5.928E+00 | 1.658E+00 | −4.808E+00 |
| coefficient(J) | | | | | | | | |
| 22nd order | −3.921E−02 | −3.025E−01 | 1.361E−01 | 1.255E−01 | −1.605E+00 | 2.539E+00 | −9.760E−01 | 2.779E+00 |
| coefficient(L) | | | | | | | | |
| 24th order | 8.075E−03 | 7.953E−02 | −3.308E−02 | −2.395E−02 | 5.453E−01 | −7.584E−01 | 3.913E−01 | −1.106E+00 |
| coefficient(M) | | | | | | | | |
| 26th order | −1.109E−03 | −1.394E−02 | 5.205E−03 | 2.007E−03 | −1.214E−01 | 1.498E−01 | −1.021E−01 | 2.891E−01 |
| coefficient(N) | | | | | | | | |
| 28th order | 9.141E−05 | 1.462E−03 | −4.753E−04 | 9.192E−05 | 1.596E−02 | −1.754E−02 | 1.565E−02 | −4.465E−02 |
| coefficient(O) | | | | | | | | |
| 30th order | −3.419E−06 | −6.942E−05 | 1.893E−05 | −2.279E−05 | −9.402E−04 | 9.202E−04 | −1.068E−03 | 3.090E−03 |
| coefficient(P) | | | | | | | | |
| | S9 | S10 | S11 | S12 | S13 | S14 | S15 | S16 |
| Conic | 0.071 | 43.924 | −0.001 | −0.003 | 16.445 | 0.117 | 0.001 | −5.173 |
| constant (K) | | | | | | | | |
| 4th order | −2.177E−02 | −5.910E−02 | −9.350E−02 | −7.644E−02 | −1.266E−02 | −5.501E−03 | −1.042E−01 | −8.580E−02 |
| coefficient(A) | | | | | | | | |
| 6th order | 5.557E−02 | 2.230E−01 | 5.353E−02 | 4.477E−02 | −5.509E−02 | −1.593E−03 | 5.029E−02 | 4.496E−02 |
| coefficient(B) | | | | | | | | |
| 8th order | −3.344E−01 | −1.076E+00 | −3.423E−03 | −4.016E−02 | 1.143E−01 | −3.636E−03 | −2.416E−02 | −1.926E−02 |
| coefficient(C) | | | | | | | | |
| 10th order | 1.013E+00 | 3.285E+00 | −5.078E−02 | 4.374E−02 | −1.670E−01 | −5.590E−03 | 8.646E−03 | 6.048E−03 |
| coefficient(D) | | | | | | | | |
| 12th order | −2.214E+00 | −6.706E+00 | 3.149E−02 | −3.763E−02 | 1.597E−01 | 1.224E−02 | −2.072E−03 | −1.371E−03 |
| coefficient(E) | | | | | | | | |
| 14th order | 3.752E+00 | 9.486E+00 | 7.037E−02 | 2.081E−02 | −1.030E−01 | −1.062E−02 | 3.404E−04 | 2.273E−04 |
| coefficient(F) | | | | | | | | |
| 16th order | −4.974E+00 | −9.540E+00 | −1.626E−01 | −6.758E−03 | 4.548E−02 | 5.554E−03 | −3.954E−05 | −2.790E−05 |
| coefficient(G) | | | | | | | | |
| 18th order | 5.057E+00 | 6.916E+00 | 1.648E−01 | 8.586E−04 | −1.362E−02 | −1.926E−03 | 3.308E−06 | 2.546E−06 |
| coefficient(H) | | | | | | | | |
| 20th order | −3.836E+00 | −3.623E+00 | −1.018E−01 | 2.597E−04 | 2.655E−03 | 4.561E−04 | −2.004E−07 | −1.720E−07 |
| coefficient(J) | | | | | | | | |
| 22nd order | 2.109E+00 | 1.357E+00 | 4.119E−02 | −1.555E−04 | −2.960E−04 | −7.404E−05 | 8.708E−09 | 8.466E−09 |
| coefficient(L) | | | | | | | | |
| 24th order | −8.103E−01 | −3.545E−01 | −1.100E−02 | 3.703E−05 | 8.793E−06 | 8.089E−06 | −2.645E−10 | −2.947E−10 |
| coefficient(M) | | | | | | | | |
| 26th order | 2.056E−01 | 6.121E−02 | 1.872E−03 | −4.945E−06 | 2.063E−06 | −5.680E−07 | 5.322E−12 | 6.865E−12 |
| coefficient(N) | | | | | | | | |
| 28th order | −3.087E−02 | −6.276E−03 | −1.840E−04 | 3.624E−07 | −2.592E−07 | 2.314E−08 | −6.362E−14 | −9.587E−14 |
| coefficient(O) | | | | | | | | |
| 30th order | 2.076E−03 | 2.890E−04 | 7.940E−06 | −1.139E−08 | 9.622E−09 | −4.155E−10 | 3.409E−16 | 6.064E−16 |
| coefficient(P) | | | | | | | | |

Also, the optical imaging system 800 may have the aberration characteristics illustrated in FIG. 16.

TABLE 17

| Conditional | Example | Example | Example | Example | Example | Example | Example | Example |
|---|---|---|---|---|---|---|---|---|
| Expression | 1 | 2 | 3 | 4 | 5 | 6 | 7 | 8 |
| f1/f | 0.804 | 0.817 | 0.877 | 0.900 | 1.033 | 0.825 | 0.811 | 1.039 |
| v1 − v2 | 35.590 | 35.590 | 37.590 | 37.590 | 37.590 | 37.590 | 35.590 | 37.590 |
| v1 − v4 | 0 | 0 | 0 | 18.59 | 18.59 | 0 | 0 | 0 |
| v1 − (v6 + v7)/2 | 24.320 | 24.320 | 24.320 | 24.320 | 25.340 | 24.320 | 24.320 | 24.320 |
| f2/f | −2.071 | −2.011 | −2.406 | −2.597 | −1.929 | −2.181 | −1.851 | −2.004 |
| \|f3/f\| | 98.920 | 22.552 | 6.498 | 5.309 | 2.045 | 76.832 | 155.825 | 2.185 |
| \|f4/f\| | 3.970 | 4.360 | 10.751 | 12.662 | 9.224 | 4.805 | 3.980 | 7.150 |
| \|f5/f\| | 4.279 | 4.044 | 4.758 | 4.731 | 3.612 | 15.353 | 6.217 | 3.439 |
| \|f6/f\| | 6.038 | 14.830 | 26.917 | 10.766 | 10.963 | 2.823 | 5.888 | 10.737 |
| f7/f | 1.271 | 1.371 | 1.396 | 1.373 | 1.717 | 1.132 | 1.244 | 1.660 |
| f8/f | −0.817 | −0.795 | −0.788 | −0.823 | −0.806 | −0.773 | −0.767 | −0.809 |
| TTL/f | 1.123 | 1.124 | 1.128 | 1.119 | 1.104 | 1.125 | 1.129 | 1.110 |
| f1/f2 | −0.388 | −0.406 | −0.365 | −0.346 | −0.535 | −0.378 | −0.438 | −0.519 |
| f1/f3 | −0.008 | 0.036 | 0.135 | 0.169 | 0.505 | −0.011 | −0.005 | 0.475 |
| \|f2/f3\| | 0.021 | 0.090 | 0.373 | 0.493 | 0.951 | 0.029 | 0.012 | 0.964 |
| f34/f | 4.189 | 3.714 | 4.111 | 3.799 | 1.696 | 5.200 | 4.160 | 1.661 |
| BFL/f | 0.165 | 0.170 | 0.172 | 0.173 | 0.158 | 0.162 | 0.163 | 0.175 |
| D1/f | 0.004 | 0.004 | 0.010 | 0.009 | 0.004 | 0.005 | 0.005 | 0.005 |
| D3/f | 0.112 | 0.134 | 0.133 | 0.121 | 0.194 | 0.100 | 0.084 | 0.181 |
| TTL/(2 × IMG HT) | 0.579 | 0.579 | 0.579 | 0.579 | 0.579 | 0.579 | 0.579 | 0.583 |
| FOV × (IMG HT/f) | 82.690 | 82.754 | 83.024 | 82.366 | 81.295 | 82.864 | 83.132 | 81.268 |
| v2 + v5 + v6 | 66.740 | 66.740 | 62.740 | 62.740 | 60.700 | 62.740 | 66.740 | 62.740 |

According to the aforementioned examples, the optical imaging system may have a reduced size while implementing high resolution.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system, comprising:
a first lens having positive refractive power;
a second lens having negative refractive power;
a third lens having refractive power;
a fourth lens having positive refractive power;
a fifth lens having negative refractive power;
a sixth lens having refractive power,
a seventh lens having positive refractive power; and
an eighth lens having negative refractive power,
wherein the first to eighth lenses are disposed in order from an object side,
wherein the optical imaging system has a total of eight lenses,
wherein
$$0 < \vert f 2 / f 3 \vert < 1 ;$$
$$3 < \vert f 4 / f \vert ;$$
$$and$$
$$0 < f 7 / f < 2 ,$$
where f2 is a focal length of the second lens, f3 is a focal length of the third lens, f4 is a focal length of the fourth lens, f7 is a focal length of the seventh lens, and f is a total focal length of the optical imaging system.

2. The optical imaging system of claim 1,
wherein, among the first to eighth lenses, at least three lenses including the second lens have a refractive index greater than 1.61, and
wherein, among the at least three lenses having a refractive index greater than 1.61, an absolute value of a focal length of the second lens is the smallest.

3. The optical imaging system of claim 1, wherein at least one of 25<v1−v2<45, and v1−v4<45 is satisfied, where v1 is an Abbe number of the first lens, v2 is an Abbe number of the second lens, and v4 is an Abbe number of the fourth lens.

4. The optical imaging system of claim 1, wherein 60<v2+v5+v6<80, where v2 is an Abbe number of the second lens, v5 is an Abbe number of the fifth lens, and v6 is an Abbe number of the sixth lens.

5. The optical imaging system of claim 1, wherein each of the second lens and the fifth lens has a refractive index greater than 1.66.

6. The optical imaging system of claim 1, wherein 0<f1/f<1.4, where f1 is a focal length of the first lens.

7. The optical imaging system of claim 1,
wherein at least one of
$$- 10 < f 2 / f < - 1 ;$$
$$and$$
$$1 < \vert f 3 / f \vert$$
is satisfied.

8. The optical imaging system of claim 1, wherein −0.6<f1/f2<0, where f1 is a focal length of the first lens.

9. The optical imaging system of claim 1, wherein 3<|f5/f|, where f5 is a focal length of the fifth lens.

10. The optical imaging system of claim 1, wherein 1<|f6/f|, where f6 is a focal length of the sixth lens.

11. The optical imaging system of claim 1, wherein −1<f8/f<0, where f8 is a focal length of the eighth lens.

12. The optical imaging system of claim 1, wherein TTL/f<1.3 and BFL/f<0.3, where TTL is a distance on an optical axis from an object-side surface of the first lens to an imaging plane, and BFL is a distance on the optical axis from an image-side surface of the eighth lens to the imaging surface.

13. The optical imaging system of claim 1, wherein 0<D1/f<0.1, where D1 is a distance on the optical axis from an image-side surface of the first lens to an object-side surface of the second lens.

14. The optical imaging system of claim 1, wherein 70°<FOV×(IMG HT/f), where FOV is a field of view of the optical imaging system, and IMG HT is half a diagonal length of an imaging plane.

15. The optical imaging system of claim 1, wherein the third lens has negative refractive power.

16. The optical imaging system of claim 1, wherein the sixth lens has negative refractive power.

17. The optical imaging system of claim 1, wherein the first lens has a convex object-side surface in a paraxial region thereof and a concave image-side surface in a paraxial region thereof, the second lens has a convex object-side surface in a paraxial region thereof and a concave image-side surface in a paraxial region thereof, and the third lens has a convex object-side surface in a paraxial region thereof and a concave image-side surface in a paraxial region thereof.

18. The optical imaging system of claim 1, wherein the fifth lens has a convex object-side surface in a paraxial region thereof and a concave image-side surface in a paraxial region thereof, the seventh lens has a convex object-side surface in a paraxial region thereof and a concave image-side surface in a paraxial region thereof, and the eighth lens has a convex object-side surface in a paraxial region thereof and a concave image-side surface in a paraxial region thereof.

19. The optical imaging system of claim 1, wherein the fourth lens has a convex object-side surface in a paraxial region thereof and a concave image-side surface in a paraxial region thereof.

20. The optical imaging system of claim 1, wherein the sixth lens has a concave image-side surface in a paraxial region thereof.
